(19) United States
(12) Patent Application Publication
(10) Pub. No.: US 2019/0221082 A1
(43) Pub. Date: Jul. 18, 2019

(54) GAMBLING HYBRID GAME WITH A GAMBLING INTEGRATED GAME GAMING SYSTEM

(71) Applicant: Gamblit Gaming, LLC, Glendale, CA (US)

(72) Inventors: Miles Arnone, Sherborn, MA (US); Eric Meyerhofer, Pasadena, CA (US); Frank Cire, Pasadena, CA (US)

(21) Appl. No.: 16/364,116

(22) Filed: Mar. 25, 2019

Related U.S. Application Data
(63) Continuation-in-part of application No. 14/869,819, filed on Sep. 29, 2015, now abandoned.
Application No. 14/869,819 is a continuation of application No. PCT/US14/32432, filed on Mar. 31, 2014.
(60) Provisional application No. 61/817,807, filed on Apr. 30, 2013.
(60) Provisional application No. 61/806,579, filed on Mar. 29, 2013.

(51) Int. Cl. G07F 17/32

(52) U.S. Cl. CPC G07F 17/3295; G07F 17/3223; G07F 17/3244; G07F 17/3239

(57) ABSTRACT

A gambling hybrid game with a gambling integrated game is disclosed. The gambling hybrid game includes an entertainment system engine that provides an entertainment game to a user, a real world engine that provides gambling games to one or more users, and a game world engine that monitors the entertainment game and provides gambling games when appropriate. The entertainment system engine provides an entertainment game that includes random events. When a random event occurs in the entertainment game, the entertainment system engine resolves the random event and provides the results of the random event to the game world engine. The game world engine receives the results of the random event and determines gambling results based upon the results of the random event.

### CROSS REFERENCE TO RELATED APPLICATIONS

This application is a continuation-in-part of U.S. application Ser. No. 14/869,819 filed Sep. 29, 2015, which is a continuation of Patent Cooperation Treaty Application No. PCT/US14/32432, filed Mar. 31, 2014, which claims the benefit of U.S. Provisional Application No. 61/817,807, filed Apr. 30, 2013, and U.S. Provisional Application No. 61/806,579, filed Mar. 29, 2013, the disclosures of which are incorporated herein by reference as if set forth herewith.

### FIELD OF THE INVENTION

Embodiments of the invention are generally related to data processing systems. More particularly, embodiments of the invention relate to data processing systems that implement hybrid gaming wagering processes.

### BACKGROUND

The gaming machine manufacturing industry has traditionally developed gaming machines with a simple gambling game. A simple gambling game is a game of chance where the outcome of the game is dependent solely on chance (such as a slot machine). A game of chance can be contrasted with a game of skill where the outcome of the game may depend upon a player's skill with the game. Simple gambling games are not as interactive and do not include graphics as sophisticated as an entertainment game, which may be a game of skill such as a video game.

For example, U.S. Pat. No. 6,905,405 to McClintic describes a simple gaming device provided with a central processor (CPU) operably coupled to controlling software memory, which includes assigned memory locations storing game software and system software. Such controlling software memory dictates when selected graphics or messages are displayed to a player, as well as when play sequences begin and end and management of wager input and award output. The CPU is also operably coupled to a second memory, which is employed to store data indicative of game statistics, number of plays, number of wins, etc. Controlling software memory, a second memory, or other, ancillary memory store data indicative of winning results, such as data representative of one or more symbol combinations, including winning combinations. Second memory may also be used, for example, to store a bit map of the symbol pattern depicted as a matrix display on video monitor. In operation of the gaming device the CPU carries out instructions of the system software to implement an initial display pattern on the video monitor and to enable the input devices. After a wager is received a player activates an initiator element such as a handle, a physical button or a touch screen to initiate a play sequence. At this point, the game software, in conjunction with a random number generator, generates a random symbol configuration at for a random final outcome comprised of a pattern of symbols for depiction on video monitor. System software then animates the video monitor by simulating the movement of visible representations of symbol carriers including symbols thereon so that the player perceives symbol carrier rotational “movement” of each symbol carrier as well as, optionally, rotational movement of the entire group of symbol carriers about a common axis. Once the visible representations of the symbol carriers have stopped, all of the generated, displayed symbols comprising a winning combination or combinations in the matrix display are identified or flagged. The displayed results (pattern of symbols depicted on the video monitor, which may include symbols received from a remote location, is compared with data stored in game software representing winning combinations to determine if any displayed combination on an active pay line is a winning combination. Any identified winning combination or combinations of symbols are then associated with winnings to be distributed to the player according to a paytable of the game software associated with the various possible winning combinations. The various pay line configurations and required combinations of the various indicia for a winning combination within each pay line reside within the game software and are retrieved for comparison to the randomly generated pattern of indicia depicted on the video monitor.

Operation of another simple gaming system is described in U.S. Pat. No. 6,409,602 issued to Wiltshire et al. A game program is executed on server/host computer. It is then determined whether an image is to be displayed on a screen of a client/terminal computer. If so, an image is sent from the server/host computer to client/terminal computer. The image may include any type of graphical information including a bitmap, a JPEG file, a TIFF file or even an encoded audio/video stream such as a compressed video MPEG stream. The image is generated by game computer program and passed to server/host interface program. In turn, the image is transferred over communication pathways to client/terminal computer via the network services provided by server operating system. The image is received by a client/terminal program executing on the client/terminal computer via the network services provided by client operating system. The client/terminal program then causes the image to be displayed on a screen of the client/terminal computer. It is then determined whether an input command has been entered by the patron using the client/terminal.

However, a need exists to implement more complex wagering processes and simple gaming devices are not capable of implementing these complex wagering processes. Various aspects and embodiments of the invention meet such a need.

### SUMMARY

In an embodiment, a system for providing a gambling hybrid game that includes an entertainment game of skill and a gambling game, includes a processing device, connected to a game world server via a network, constructed to execute the entertainment game of skill to resolve a random event in the entertainment game of skill to generate a random event result, detect the random event is to occur during execution of the entertainment game of skill, communicate, to the game world server via the network, a signal including the random event result, receive, from the game world server via the network, a signal including a wager result based upon the random event result, and display the wager result based upon the random event result.

In accordance with embodiments of this invention, a system for providing a gambling hybrid game that includes an entertainment game of skill and a gambling game, further includes a real world server, connected to the game world server via a communication link, constructed to receive, from the game world server via the communication link, a signal including a request of a resolution to the wager based on the random event result, determine the wager result based upon the random event result, and communicate, to the game world server via the communication link, the signal including the wager result based upon the random event result.

In accordance with embodiments of this invention, a system for providing a gambling hybrid game that includes an entertainment game of skill and a gambling game, further includes the game world server, connected to the processing device via the network and connected to the real world server via the communication link, constructed to continuously monitor the processing device for the signal including the random event result, receive, from the processing device via the network, the signal including the random event result, determine whether to request a resolution to the wager based on the signal including the random event result, communicate, to the real world server via the communication link, the signal including the request of the resolution to the wager based on the random event result, receive, from the real world server via the communication link, the signal including the wager result based upon the random event result, and communicate, to the processing device via the network, the signal including the wager result based upon the random event result.

In accordance with many embodiments, the game world server receives player information from a player management system and uses the random event result and the player information to determine the wager result for the random event.

In accordance with various embodiments, the game world server receives game provider information from a game provider system and uses the random event result and the game provider information to determine the wager result for the random event.

In accordance with numerous embodiments, the wager result contributes to a bonus pool that is awarded as a function of a subsequent random event.

In accordance with many embodiments, the game world server generates an odds table for the random event.

In another embodiment of the invention, a single game world engine controller may provide services to two or more entertainment software engine controllers, thus allowing a gambling hybrid game with a gambling integrated game gaming system to operate more efficiently over a large range of scaling.

In another embodiment of the invention, multiple types of entertainment software engine controllers using different operating systems may be interfaced to a single type of game world engine controller without requiring customization of the game world engine controller, thus improving the efficiency of the game world engine controller by reducing complexity associated with maintaining separate game world engine controllers for each type of entertainment software engine controller.

In another embodiment of the invention, an entertainment software engine controller may be provided as a player device under control of a player while maintaining the game world engine controller in an environment under the control of a regulated operator of wagering systems.

In another embodiment of the invention, data communicated between the controllers may be encrypted to increase security of the gambling hybrid game with a gambling integrated game gaming system.

In another embodiment of the invention, an entertainment game may require extensive processing resources from an entertainment software engine controller leaving few processing resources for the functions performed by a game world engine controller. By virtue of an architecture of some embodiments of the invention, processing loads may be distributed across multiple devices so that operations of the entertainment software engine controller may be dedicated to an entertainment game and the processes of the game world engine controller are not burdened by the requirements of the entertainment game.

In another embodiment of the invention, a gambling hybrid game with a gambling integrated game gaming system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like. In many embodiments, one or more components of a gambling hybrid game with a gambling integrated game gaming system are distributed in close proximity to each other and communicate using a local area network and/or a communication bus. In several embodiments, an entertainment software engine controller and a game world engine controller of a gambling hybrid game with a gambling integrated game gaming system are in a common location. In some embodiments, a game world engine controller communicates with an external entertainment software engine controller. In various embodiments, these multiple controllers and subcontrollers can be constructed from or configured using a single device or a plurality of devices so that a gambling hybrid game with a gambling integrated game gaming system is executed as a system in a virtualized space such as, but not limited to, where a real world engine subcontroller and a game world engine controller are large scale centralized servers and are operatively connected to distributed entertainment software engine controllers via a wide area network such as the Internet or a local area network. In embodiments, the components of a gambling hybrid game with a gambling integrated game gaming system may communicate using a networking protocol or other type of device-to-device communications protocol.

In another embodiment of the invention, an entertainment software engine controller is an entertainment game server acting as a host for managing head-to-head player interactions over a network of interactive subcontrollers connected to the interactive server using a communication link. The interactive server provides a distributed environment where players can compete directly with one another and interact with other players.

### BRIEF DESCRIPTION OF THE DRAWINGS

FIG. 1 is block diagram of a gambling hybrid game with a gambling integrated game gaming system in accordance with various embodiments of the invention.

FIG. 2 is a diagram of a structure of a gambling hybrid game with a gambling integrated game gaming system in accordance with various embodiments of the invention.

FIG. 3A is a diagram of an electronic gaming machine configuration of a gambling hybrid game with a gambling integrated game gaming system in accordance with various embodiments of the invention.

FIG. 3B is a diagram of a table electronic gaming machine configuration of a gambling hybrid game with a gambling integrated game gaming system in accordance with various embodiments of the invention.

FIG. 3C is a diagram of a virtual reality gaming machine configuration of a gambling hybrid game with a gambling integrated game gaming system in accordance with various embodiments of the invention.

FIG. 4 is a diagram of distributed gambling hybrid game with a gambling integrated game gaming systems in accordance with various embodiments of the invention.

FIGS. 5A and 5B are diagrams of a structure of an entertainment software engine controller of a gambling hybrid game with a gambling integrated game gaming system in accordance with various embodiments of the invention.

FIG. 6 is a diagram of a structure of a game world engine controller of a gambling hybrid game with a gambling integrated game gaming system in accordance with various embodiments of the invention.

FIGS. 7A and 7B are sequence diagrams of interactions between components of a gambling hybrid game with a gambling integrated game gaming system in accordance with various embodiments of the invention.

FIG. 8 illustrates a flow diagram of a gambling hybrid game with a gambling integrated game in accordance with an embodiment of the invention.

FIG. 9 illustrates a flow diagram of a gambling hybrid game with a gambling integrated game in accordance with another embodiment of the invention.

FIG. 10 illustrates a diagram showing a gambling hybrid game with a gambling integrated game engine and the inputs and outputs of a gambling integrated game engine in accordance with an in an embodiment of the invention.

FIG. 11 illustrates a flow diagram of a gambling hybrid game with a gambling integrated game having a gambling integrated game engine in accordance with another embodiment of the invention.

FIG. 12 illustrates a flow diagram of a gambling hybrid game with a gambling integrated game that provides a strategy game as the entertainment game in accordance with another embodiment of the invention.

FIG. 13 illustrates a flow diagram of a gambling hybrid game with a gambling integrated game that provides a letter tile game as the entertainment game in accordance with another embodiment of the invention.

FIG. 14 illustrates a timing chart showing components of a gambling hybrid game providing a gambling integrated game in accordance with an embodiment of the invention.

### DETAILED DESCRIPTION

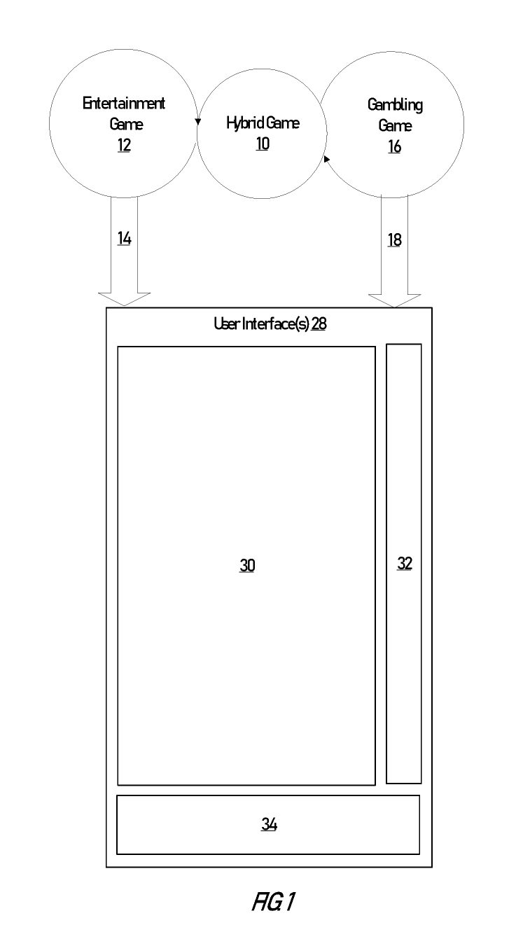

FIG. 1 is a block diagram illustrating a user interface and display of a gambling hybrid game with a gambling integrated game gaming system in accordance with various embodiments of the invention. A gambling hybrid game with a gambling integrated game gaming system executes a hybrid game 10 having an entertainment game 12 and a gambling game 16. The entertainment game 12 communicates entertainment game data 14 to one or more user interfaces 28 that are used to display to a player an interactive presentation generated based on the entertainment game data 14. The gambling game 16 communicates gambling game data 18 to the one or more user interfaces 28 that are used to display to the player an interactive presentation generated based on the gambling game data 18. By utilizing the one or more user interfaces 28, the gambling hybrid game with a gambling integrated game gaming system can integrate entertainment game events and gambling game outcomes into a user interface and communicate a state of a hybrid gaming wagering process to the player all the while running seamlessly from the player's perspective.

The one or more user interfaces 28 include one or more entertainment game user interface portions 30 having a display used to display to a player interactive objects that the player interacts with during gameplay of an entertainment game of a hybrid gaming wagering process. In many embodiments, the one or more user interfaces 28 also include one or more gambling game user interface portions 34 having a display used to display to a player a status of a gambling game of a hybrid gaming wagering process. In many embodiments, the one or more user interfaces 28 also include one or more gambling game process user interface portions 32 having a display used to display to a player a gambling game outcome generation process such as, but not limited to, a generation process of one or more gambling game outcomes.

In some embodiments, the gambling hybrid game with a gambling integrated game gaming system's user interfaces and associated displays allow transparent coupling of an entertainment game to wagering propositions, providing a seamless perspective to the player that they are playing an entertainment game. In accordance with some embodiments, a hybrid gaming wagering system can be used to enable a wide range of interactive video games including but not limited to popular titles from arcade and home video games, such as but not limited to, Gears of War (a third person shooter game developed by Epic Games of Cary, N.C.), Time Crisis (a shooter arcade game developed by Namco Ltd of Tokyo, Japan), or Madden Football (an American football video game developed by EA Tiburon of Maitland, Fla.).

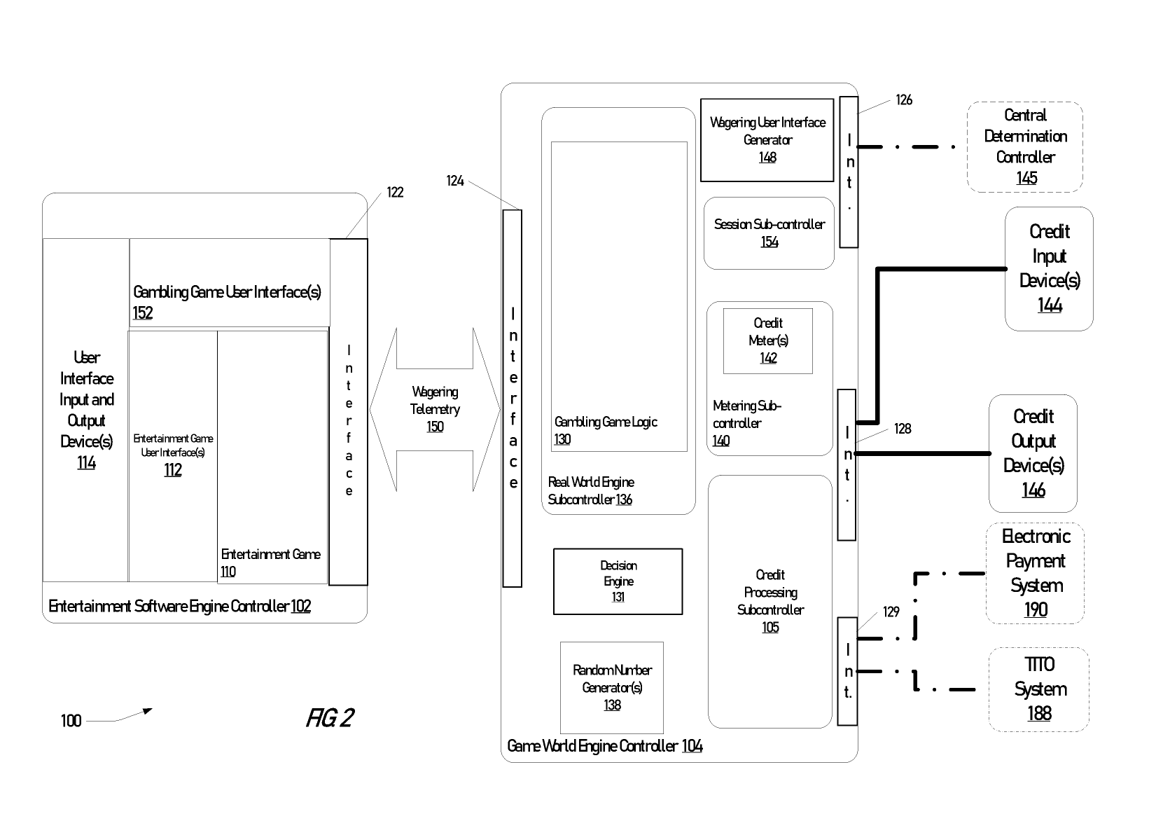

FIG. 2 is a diagram of an architecture of a gambling hybrid game with a gambling integrated game gaming system in accordance with various embodiments of the invention. The gambling hybrid game with a gambling integrated game gaming system is designed to implement a hybrid gaming wagering process through the initiation, detection, and processing of hybrid game events. The gambling hybrid game with a gambling integrated game gaming system 100 includes an entertainment software engine controller 102 and a game world engine controller 104. The game world engine controller 104 is also operatively connected to, and communicates with, various credit input and credit output devices and/or systems, such as one or more credit input devices 144, one or more credit output devices 146, a electronic payment system 190 and/or a ticket-in-ticket-out system 188, using a credit processing subcontroller 105.

In various embodiments, the entertainment software engine controller 102 detects player interactions with a hybrid gaming wagering process implemented by a gambling hybrid game with a gambling integrated game gaming system. The entertainment software engine controller 102 executes an entertainment game 110 and provides one or more user interface user input and output devices 114 so that one or more players can interact with the entertainment game 110. In various embodiments, user input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user output devices include, but are not limited to: audio output devices such as speakers, headphones, earbuds, and the like; visual output devices such as lights, video displays and the like; and tactile devices such as rumble pads, hepatic touch screens, buttons, keys and the like. The entertainment software engine controller 102 provides for player interactions with the entertainment game 110 by executing the entertainment game 110 that generates an interactive user interface 112 that utilizes the user input devices to detect player interactions with interactive elements of the entertainment game 110 of the entertainment software engine controller 102 and generates an interactive user interface that is presented to the player utilizing the user output devices.

In some embodiments, one or more components of an entertainment software engine controller are housed in an enclosure such as a housing, cabinet, casing or the like. The enclosure further includes one or more player accessible openings or surfaces constructed to mount the user input devices and/or the user output devices.

The entertainment software engine controller 102 is operatively connected to, and communicates with, the game world engine controller 104. The entertainment software engine controller 102 receives entertainment game resource data, as part of wagering telemetry data 150, including but not limited to, random number data from the game world engine controller 104.

In some embodiments, during execution of the entertainment game 110 by the entertainment software engine controller 102, the entertainment software engine controller 102 communicates, as part of wagering telemetry data 150, detected player interactions with one or more interactive elements of the interactive user interfaces 112 of the entertainment game 110, to the game world engine controller 104. The hybrid gaming wagering telemetry data may include, but is not limited to, entertainment game variables that indicate the state of the entertainment game 110, entertainment software engine controller data indicating a status of the entertainment software engine controller 102, detected player actions and interactions between one or more players and the entertainment game 110, and utilization of interactive elements of the entertainment game 110 by one or more players.

In some embodiments, the entertainment game 110 is a skill-based entertainment game, such as but not limited to a skill-based game. In embodiments, during execution of the skill-based entertainment game 110 by the entertainment software engine controller 102, the entertainment software engine controller 102 detects the players' skillful interaction with interactive elements of the entertainment game 110 during the players' skillful interaction with the skill-based entertainment game 110 to achieve an objective of the skill-based game. The game world engine controller 104 communicates with the entertainment software engine controller 102 in order to allow the coupling of the skill-based entertainment game 110 to gambling game outcomes generated in accordance with a hybrid gaming wagering process implemented by the game world engine controller 104 and/or the entertainment software engine controller 102.

In various embodiments, a gambling hybrid game with a gambling integrated game gaming system can include an entertainment game 110 that provides for player versus player (PvP) competitive play between a single player and a computing device, between two or more players against one another, or multiple players playing against a computing device and/or each other.

In some embodiments, the entertainment software engine controller 102 includes one or more sensors (not shown) that sense various aspects of the physical environment of the entertainment software engine controller 102. Examples of sensors include, but are not limited to: global positioning sensors (GPSs) for sensing communications from a GPS system to detect a position or location of the entertainment software engine controller; temperature sensors; accelerometers; pressure sensors; and the like. Sensor telemetry data detected from the one or more sensors are communicated by the entertainment software engine controller to the game world engine controller 104 as part of the hybrid gaming wagering telemetry data 150.

In many embodiments, the entertainment software engine controller 102 includes one or more gambling game user interfaces 152 used to display wagering data, via one or more of the user interface input and output devices 114, to one or more players. The one or more gambling game user interfaces include a display to one or more players of various wagering data that may include, but is not limited to, an amount of credits committed to a wager, a denomination of a wager, an amount of credits won as the result of a successful wager, and an amount of credits in a credit meter associated with the one or more players.

In various embodiments, an entertainment game control interface 122 resident in the entertainment software engine controller 102 provides an interface between the entertainment software engine controller 102 and the game world engine controller 104 via interface 124.

In some embodiments, interfaces 122 and 124 implement an entertainment software engine controller to game world engine controller communication protocol employing an interprocess communication protocol so that an entertainment software engine controller and a game world engine controller may be implemented on the same device. In operation, the entertainment game control interface 122 provides application programming interfaces (APIs) that are used by an entertainment game of the entertainment software engine controller to communicate outgoing data and receive incoming data by passing parameter data to another process or application.

In some embodiments, interfaces 122 and 124 implement an entertainment software engine controller to game world engine controller communication protocol employing an interdevice communication protocol so that an entertainment software engine controller and a game world engine controller may be implemented on different devices. The interdevice protocol may utilize a wired communication bus or wireless network as a physical layer.

In various embodiments, interfaces 122 and 124 implement an entertainment software engine controller to game world engine controller communication protocol employing a networking protocol so that an entertainment software engine controller and a game world engine controller may be implemented on different devices connected by a network. The networking protocol may utilize a wired communication bus or wireless network as a physical layer. In many embodiments, the network includes a cellular telephone network or the like and the entertainment software engine controller is a mobile device such as a smartphone, tablet computer or other device capable of using the telephone network. During operation, the entertainment game control interface 122 communicates outgoing data to an external device by encoding the data into a signal and transmitting the signal to an external device. The entertainment game control interface receives incoming data from an external device by receiving a signal transmitted by the external device and decoding the signal to obtain the incoming data.

In several embodiments, interfaces 122 and 124 implement an encrypted communication protocol so that data communicated between the controllers may be encrypted to increase security of the gambling hybrid game with a gambling integrated game gaming system.

In various embodiments, the game world engine controller 104 includes a real world engine subcontroller 136 that uses gambling game logic 130, and one or more random number generators 138 to initiate random number generation by the random number generators and generate gambling game outcomes used by the gambling hybrid game with a gambling integrated game gaming system to perform a hybrid gaming wagering process.

In various embodiments, gambling game outcomes include, but are not limited to, gambling game outcomes that are an amount of credits or other items having value as described herein. The gambling game outcomes are generated in accordance with gambling game logic 130 and one or more outputs from the one or more random number generators 138.

In various embodiments, gambling game outcomes include, but are not limited to, resources of an entertainment game that a player uses and/or interacts with during interaction with the entertainment game as described herein. The resources are generated in accordance with resource logic and one or more outputs from the one or more random number generators 138.

In many embodiments, the real world engine subcontroller 136 of the game world engine controller 104 works in association with entertainment game 110. In an example embodiment, the real world engine subcontroller 136 uses an output of the one or more random number generators 138 to generate a random number. The random number is then communicated to the entertainment software engine controller 102, and the entertainment software engine controller uses the entertainment game 110 to generate one or more entertainment game resources.

In several embodiments, a rule-based decision engine 131 uses the hybrid gaming wagering telemetry data 150, one or more outputs of the one or more random number generators 138, along with gambling game logic 130, to generate one or more gambling game outcomes as described herein. In embodiments, a decision engine 131 includes one or more rules as part of gambling game logic 130 used by a decision engine 131 to determine how a gambling game outcome should be generated. Each rule includes one or more variable values constituting a pattern that is to be matched by the decision engine 131 to one or more variable values encoded in an input string of data. Each rule also includes one or more actions that are to be taken if the pattern is matched. Actions can include automatically generating one or more gambling game outcomes in accordance with the gambling game logic 130 as described herein. During operation, the game world engine controller 104 receives hybrid gaming wagering telemetry data 150 from the entertainment software engine controller 102. The real world engine subcontroller uses decision engine 131 to perform a matching process of matching the variable values encoded in the hybrid gaming wagering telemetry data 150 to one or more variable patterns of one or more rules. If a match between the variable values and a pattern of a rule is detected, then the real world engine subcontroller 136 performs the action of the matched rule.

In various embodiments, the game world engine controller communicates data of one or more gambling game outcomes generated by the real world engine subcontroller 136 to the entertainment software engine controller 102 as a portion of the entertainment game resource data communicated to the entertainment software engine controller 102.

In some embodiments, the decision engine 131 includes one or more rules as part of gambling game logic 130 used by the decision engine to automatically generate the entertainment game resource data that is then communicated to the entertainment software engine controller 102.

In some embodiments, the entertainment game 110 operates utilizing a scripting language. The entertainment game 110 parses scripts written in the scripting language and executes commands encoded in the scripts. In operation of embodiments, the game world engine controller 104 generates interactive entertainment game resource data in the form of scripts written in the scripting language that are communicated to the entertainment software engine controller 102 during execution of the entertainment game 110. The entertainment software engine controller 102 receives the scripts and passes the m to the entertainment game 110. The entertainment game 110 receives the scripts, parses the scripts and automatically executes the commands as encoded in the scripts.

In many embodiments, the entertainment game 110 automatically performs processes as instructed by commands communicated from the game world engine controller 104. The commands command the entertainment game 110 to perform specified operations such as executing specified commands and/or setting the values of variables utilized by the entertainment game 110. In operation of embodiments, the game world engine controller 104 generates commands that are encoded into the entertainment game resource data communicated to the entertainment software engine controller 102. The entertainment software engine controller 102 passes the entertainment game resource data to the entertainment game 110. The entertainment game parses the entertainment game resource data and automatically performs operations in accordance with the commands encoded in the entertainment game resource data.

In many embodiments, the game world engine controller 104 includes one or more interfaces, such as interface 126, that operatively connect the game world engine controller 104 to one or more external devices used to generate gambling game outcomes, such as central determination controller 145. In operation, when a real world engine subcontroller 136 of the game world engine controller 104 needs a gambling game outcome, the real world engine subcontroller communicates a request to the central determination controller 145 for the gambling game outcome. The central determination controller 145 receives the gambling game outcome request and generates a gambling game outcome in response to the gambling game outcome request. The central determination controller communicates data of the gambling game outcome to the game world engine controller 104. The game world engine controller 104 receives the data of the gambling game outcome and utilizes the gambling game outcome as described herein. In some embodiments, the gambling game outcome is drawn from a pool of pre-generated gambling game outcomes.

In various embodiments, the central determination controller 145 is a progressive controller that is operatively connected to a plurality of gambling hybrid game with a gambling integrated game gaming systems (not shown). The progressive controller provides services for the collection and provision of credits used by the game world engine controller 104 to provide wagering outcomes that have a progressive or pooling component.

In some embodiments, the game world engine controller 104 includes one or more interfaces, such as interface 128, that operatively connect the game world engine controller 104 to one or more credit input devices, such as credit input devices 144, and to one or more credit output devices, such as credit output devices 146.

In various embodiments, the game world engine controller 104 includes one or more interfaces, such as interface 129, that operatively connect the game world engine controller 104 to one or more ticket-in-ticket-out systems 188 and/or one or more electronic payment systems 190.

The game world engine controller 104 manages one or more wagers in accordance with one or more hybrid gaming wagering processes implemented by the gambling hybrid game with a gambling integrated game gaming system 100 by determining a commitment of a wager of value to the hybrid gaming wagering process, executing the hybrid gaming wagering process, and determining a wagering outcome of value of the hybrid gaming wagering process. Types of value committed to the one or more wagers can be one or more of several different types. In various embodiments, types of value of a wager can include, but are not limited to, a wager of an amount of credits corresponding to a real currency or a virtual currency, a wager of an amount of game world credit earned through interaction with an entertainment game, a wager of an amount of interactive elements of an entertainment game, and/or a wager of an amount of objects used in an entertainment game. In various embodiments, a type of value of a wagering outcome for a wager committed to a wagering process can be one or more of several different types. In various embodiments, types of value of a wagering outcome can include, but are not limited to, a wagering outcome of an amount of credits corresponding to a real currency or a virtual currency, a wagering outcome of an amount of GWC earned through interaction with an entertainment game, a wagering outcome of an amount of interactive elements of an entertainment game, and a wagering outcome of an amount of in-game objects used in an entertainment game.

In various embodiments, a type of value of a gambling game outcome of a hybrid gaming wagering process is different than a type of value of a wager commitment of the hybrid gaming wagering process. In an example embodiment, a value of a wager commitment can be an amount of credits, and a value of a wagering outcome can be an in-game object of an entertainment game.

In many embodiments, the game world engine controller 104 includes one or more random number generators (RNGs) having a known stochastic behavior 138 for generating non-deterministic random numbers having a known probability distribution. The real world engine subcontroller 136 uses outputs from the one or more random number generators 138 along with the gambling game logic 130 to generate one or more gambling game outcomes as described herein.

In many embodiments, the one or more random number generators 138 generate random numbers by continuously generating pseudorandom numbers using one or more pseudorandom number generators. A most current pseudorandom number is stored in a buffer thus constantly refreshing the buffer. In many embodiments, the buffer is refreshed at a rate of approximately 100 times per second. When the real world engine subcontroller 136 requests a random number to be used to generate a gambling game outcome, a random number generator outputs the stored most current pseudorandom number from the buffer. As timing between the requests for a random number is non-deterministic, the resulting output from the buffer is a true non-deterministic random number. In some embodiments, a random number generator includes a plurality of pseudorandom number generators that generate and store pseudorandom numbers into a respective plurality of buffers wherein each of the pseudorandom number generators is seeded with a different seed. When a request is made for a random number, the random number generator generates an additional pseudorandom number and on the basis of the additional pseudorandom number, randomly selects a respective buffer to output the requested random number. In some embodiments, a respective buffer is randomly chosen by hashing a value from a realtime clock circuit to create a random index value that is then used to select from between the respective buffers.

In some embodiments, an objective is generated by a gambling hybrid game with a gambling integrated game gaming system by executing objective generation commands included in objective logic that define processes of a hybrid gaming wagering process where the objective generation commands are formatted in a scripting language. In operation, a decision engine of a game world engine controller generates the objective generation commands in the form of a script written in the scripting language. The script includes the objective generation commands that describe how the real world engine subcontroller is to generate data of an objective. The real world engine subcontroller parses the script encoded in the objective generation command data and executes the commands included in the script to generate data of the objective.

In some embodiments, a gambling game outcome is generated by a gambling hybrid game with a gambling integrated game gaming system by executing gambling game outcome generation commands included in gambling game outcome logic to generate a random number and use the random number as in index into a lookup table having stored data of a plurality of gambling game outcomes.

In various embodiments, a game world engine controller uses a rule-based decision engine to automatically generate an amount of GWC to award to a player based at least in part on hybrid gaming wagering telemetry data including player interaction data with an entertainment game of the gambling hybrid game with a gambling integrated game gaming system. In numerous embodiments, the entertainment game is a skill-based entertainment game and the GWC are awarded for a player's skillful interaction with the entertainment game.

In several embodiments, the game world engine controller 104 includes a metering subcontroller 140. The metering subcontroller 140 communicates with the credit processing subcontroller 105 to receive incoming credit data from the credit processing subcontroller 105. The metering subcontroller 140 uses the incoming credit data to transfer credits into the gambling hybrid game with a gambling integrated game gaming system and onto one or more credit meters 142 associated with one or more players. The metering subcontroller 140 communicates outgoing credit data to the credit processing subcontroller 105 to transfer credits off of the one or more credit meters 142 and out of the gambling hybrid game with a gambling integrated game gaming system.

In various embodiments, the credit process subcontroller 105 and metering subcontroller 140 process types of value committed to the one or more wagers other than credits. In embodiments, the types of value can be one or more of several different types including, but not limited to, credits corresponding to a real currency or a virtual currency, GWC earned through interaction with an entertainment game, interactive elements of an entertainment game, and/or objects used in an entertainment game.

In some embodiments, the real world engine subcontroller 136 uses a gambling game user interface generator 148 to automatically generate wagering telemetry data 150 on the basis of amounts of credits on the one or more credit meters 142. The wagering telemetry data 150 is used by the game world engine controller 104 to command the entertainment software engine controller 102 to automatically generate one or more gambling game user interfaces 152 having a display describing a state of wagered credit accumulation and loss for the gambling hybrid game with a gambling integrated game gaming system. When a player interacts with the one or more gambling game user interfaces 152, gambling game user interface telemetry data 150 is generated by the one or more gambling game user interfaces 152 and communicated by the entertainment software engine controller 102 to the game world engine controller 104 using interfaces 122 and 124.

In some embodiments, the wagering telemetry data 150 may include, but is not limited to, amounts of GWC and interactive elements earned, lost or accumulated through interaction with the entertainment game 110, and credits, GWC and interactive elements amounts won, lost or accumulated.

In some embodiments, the entertainment game resource data are communicated to the gambling game user interface generator 148 and used as a partial basis for generation of the wagering telemetry data 150 communicated to the entertainment software engine controller 102.

In various embodiments, the gambling game user interface generator 148 also receives hybrid gaming wagering process state data that is used as a partial basis for generation of the wagering telemetry data 150 communicated to the entertainment software engine controller 102. In some embodiments, the hybrid gaming wagering process state data includes gambling game outcome data generated by the real world engine subcontroller 136 during the generation of gambling game outcomes. In various embodiments, the gambling game user interface generator 148 generates a gambling game outcome generation display using the one or more states of the hybrid gaming wagering process. The gambling game outcome generation display is included in the wagering telemetry data 150 that is communicated to the entertainment software engine controller 102. The gambling game outcome generation display is automatically displayed by the entertainment software engine controller 102 using the one or more gambling game user interfaces 152. In other embodiments, the hybrid gaming wagering process state data are communicated to the entertainment software engine controller 102 and the entertainment software engine controller 102 is instructed to automatically generate the gambling game outcome generation display of the one or more gambling game user interfaces 152.

In some embodiments, the hybrid gaming wagering process state data includes, but is not limited to, a final state, an intermediate state, a beginning state, and/or an award state of the hybrid gaming wagering process. For example, in a hybrid gaming wagering process that is based on slot machine math, the final state of the hybrid gaming wagering process may be reel positions, in a hybrid gaming wagering process that is based on roulette wheel math, the final state may be a pocket where a ball may have come to rest, in a hybrid gaming wagering process that is a based on card math, the beginning, intermediate and final states may represent a sequence of cards being drawn from a deck of cards, etc.

In some embodiments, an entertainment software engine controller generates a gambling game user interface by executing commands that define processes of the gambling game user interface where the commands are formatted in a scripting language. In operation, a gambling game user interface generator of a game world engine controller generates commands in the form of a script written in the scripting language. The script includes commands that describe how the entertainment software engine controller is to display hybrid gaming wagering process state data. The completed script is encoded as wagering telemetry data and communicated to the entertainment software engine controller by the game world engine controller. The entertainment software engine controller receives the wagering telemetry data and parses the script encoded in the wagering telemetry data and executes the commands included in the script to generate the gambling game user interface.

In many embodiments, an entertainment software engine controller generates a gambling game user interface based on a document written in a document markup language that includes commands that define processes of the gambling game user interface. In operation, a gambling game user interface generator of a game world engine controller generates a document composed in the document markup language. The document includes commands that describe how the entertainment software engine controller is to display hybrid gaming wagering process state data. The completed document is encoded as wagering telemetry data and communicated to the entertainment software engine controller by the game world engine controller. The entertainment software engine controller receives the wagering telemetry data and parses the document encoded in the wagering telemetry data and executes the commands encoded into the document to generate the gambling game user interface.

In some embodiments, an entertainment software engine controller generates a gambling game user interface by executing commands that define processes of the gambling game user interface. In operation, a gambling game user interface generator of a game world engine controller generates the commands and encodes the commands into wagering telemetry data that is communicated to the entertainment software engine controller by the game world engine controller. The entertainment software engine controller receives the wagering telemetry data and executes the commands encoded in the wagering telemetry data to generate the gambling game user interface.

In various embodiments, an entertainment software engine controller includes a data store of graphic display and audio presentation resources that the entertainment software engine controller uses to generate a gambling game user interface as described herein.

In many embodiments, a game world engine controller communicates graphic display and audio presentation resources as part of wagering telemetry data to an entertainment software engine controller. The entertainment software engine controller uses the graphic display and audio presentation resources to generate a gambling game user interface as described herein.

In various embodiments, the gambling game user interface generator 148 processes various types of value committed to one or more wagers. In embodiments, the types of value can be one or more of several different types including, but not limited to, credits corresponding to a real currency or a virtual currency, GWC earned through interaction with an entertainment game, interactive elements of an entertainment game, and/or objects used in an entertainment game.

In some embodiments, the game world engine controller 104 utilizes the one or more gambling game user interfaces 152 to display certain entertainment game data to the player, including but not limited to, club points, player status, control of the selection of choices, and messages which a player can find useful in order to adjust the entertainment game experience or understand the wagering status of the player.

In some embodiments, the game world engine controller 104 utilizes the one or more gambling game user interfaces 152 to display aspects of a hybrid gaming wagering process to a player including, but not limited to, amount of credits, GWC, interactive elements, or objects in play, and amounts of credits, GWC, interactive elements, or objects available.

In a number of embodiments, the real world engine subcontroller 136 can accept hybrid gaming wagering process factors including, but not limited to, modifications in the amount of credits, GWC, interactive elements, or objects wagered on each individual wagering event, entrance into a bonus round, and other factors. In several embodiments, the game world engine controller 104 can communicate a number of factors back and forth to the real world engine subcontroller, so that an increase/decrease in a wagered amount can be related to the change in player profile of the player in the entertainment game. In this manner, a player can control a wager amount per wagering event in accordance with the hybrid gaming wagering process with the change mapping to a parameter or component that is applicable to the entertainment game experience.

In some embodiments, the game world engine controller 104 includes a session subcontroller 154 is used to regulate a gambling hybrid game with a gambling integrated game gaming system session. In various embodiments, components of the game world engine controller 104 communicate session data to the session subcontroller 154. The session data may include, but is not limited to, player data, entertainment software engine controller data, pooled bet and side bet data, game world engine controller data and real world engine subcontroller data used by the session subcontroller to regulate a gambling hybrid game with a gambling integrated game gaming system session.

In some embodiments, the session subcontroller 154 may also assert control of a gambling hybrid game with a gambling integrated game gaming system session by communicating session control data to components of the game world engine controller 104. Such control may include, but is not limited to, commanding the game world engine controller 104 to end a gambling hybrid game with a gambling integrated game gaming system session, initiating wagering in a gambling hybrid game with a gambling integrated game gaming system session, ending wagering in a gambling hybrid game with a gambling integrated game gaming system session but not ending a player's use of the entertainment game portion of the gambling hybrid game with a gambling integrated game gaming system, and changing from real credit wagering in a gambling hybrid game with a gambling integrated game gaming system to virtual credit wagering, or vice versa.

In many embodiments, the session subcontroller 154 manages player profiles for a plurality of players. The session subcontroller 154 stores and manages data about players in order to provide authentication and authorization of players of the gambling hybrid game with a gambling integrated game gaming system 100. In some embodiments, the session subcontroller 154 also manages geolocation information to ensure that the gambling hybrid game with a gambling integrated game gaming system 100 is only used by players in jurisdictions were wagering is approved. In various embodiments, the session subcontroller 154 stores GWC that are associated with the player's use of the entertainment game of the gambling hybrid game with a gambling integrated game gaming system 100.

In some embodiments, the session subcontroller 154 communicates player and session management data to the player using a management user interface (not shown) of the entertainment software engine controller. The player interacts with the management user interface and the management user interface generates management telemetry data that is communicated to the session subcontroller 154.

In some embodiments, the real world engine subcontroller 136 communicates wagering session data to the session subcontroller 154. In various embodiments, the session subcontroller communicates wagering session control data to the real world engine subcontroller 136.

In many embodiments, the credit processing subcontroller 105 operatively connects to one or more credit input devices for generating incoming credit data from a credit input. Credit inputs can include, but are not limited to, credit items used to transfer credits. The incoming credit data are communicated by the credit processing subcontroller 105 to the metering subcontroller 140. In various embodiments, the one or more credit input devices and the it corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validator and/or coin validators that receive and validate paper and/or coin currency or tokens.

In various embodiments, the credit processing subcontroller 105 includes one or more credit output devices 146 for generating a credit output based on outgoing credit data 192 communicated from the real world engine subcontroller. Credit outputs can include, but are not limited to, credit items used to transfer credits. Types of credit output devices and the it corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing subcontroller 105 is operatively connected to, and communicates with, a TITO system 188 or the like to determine incoming credit data representing amounts of credits to be transferred into the gambling hybrid game with a gambling integrated game gaming system and to determine outgoing credit data representing amounts of credits to be transferred out of the gambling hybrid game with a gambling integrated game gaming system. In operation, the credit processing subcontroller 105 communicates with a connected credit input device, such as a bill validator/ticket scanner, used to scan a credit input in the form of a TITO ticket having indicia of credit account data of a credit account of the TITO system. The credit processing subcontroller 105 communicates the credit account data to the TITO system. The TITO system uses the credit account data to determine an amount of credits to transfer to the credit processing subcontroller 105, and thus to the metering subcontroller 140 of the game world engine controller 104. The TITO system communicates the amount of credits to the credit processing subcontroller 105. The credit processing subcontroller 105 communicates the amount of credits as incoming credit data to the metering subcontroller 140 and the metering subcontroller 140 credits one or more credit meters 142 with the amount of credits so that the credits can be used when a player makes wagers using the gambling hybrid game with a gambling integrated game gaming system 100.

In many embodiments, the credit processing subcontroller 105 is operatively connected to a bill validator/ticket scanner as one of the one or more credit input devices 144. The credit processing subcontroller 105 communicates with the bill validator/ticket scanner to scan currency used as a credit input to determine an amount of credits as incoming credit data to transfer credit to one or more credit meters 110 associated with one or more players. The skill metering subcontroller 140 credits the one or more credit meters 110 with the amount of credits so that the credits can be used when a player makes wagers using the gambling hybrid game with a gambling integrated game gaming system 100.

In some embodiments, the credit processing subcontroller 105 can use a TITO system along with a ticket or voucher printer as one of the one or more credit output devices 146 to generate a TITO ticket as a credit output for a player. In operation, the credit processing subcontroller 105 communicates, as outgoing credit data, data of an amount of credits to be credited to a credit account on the TITO system. The TITO system receives the amount of credits and creates the credit account and credits the credit account with the amount of credits. The TITO system generates credit account data for the credit account and communicates the credit account data to the credit processing subcontroller 105. The credit processing subcontroller 105 uses the ticket or voucher printer to print indicia of the credit account data onto a TITO ticket or voucher as a credit output.

In various embodiments, the credit processing subcontroller 105 provides an interface to an electronic payment management system 190 such as an electronic wallet or the like. The electronic payment system provides credit account data that is used for generating incoming credit data as a credit input and outgoing credit data as a credit output.

In several embodiments, during operation, the metering subcontroller 140 communicates with the credit processing subcontroller 105 to receive incoming credit data from the credit processing subcontroller 105 and adds credits onto the one or more credit meters 110 at least partially on the basis of the incoming credit data. The entertainment software engine controller 102 executes the entertainment game and that generates one or more entertainment game user interfaces 112. One or more players interact with the one or more interactive user interfaces 112 through the one or more user interface input and output devices 114. The entertainment game 110 detects the player interactions and determines to request a wager based on the detected interactions of the one or more players and communicates wager request data as part of the hybrid gaming wagering telemetry data 150 to the game world engine controller 104. The real world engine subcontroller 136 receives the wager request data and determines a gambling game outcome and instructs the metering subcontroller 140 to add credits to, or deduct credits from, the one or more credit meters 110 based in part on the gambling game outcome. For example, in some embodiments, the metering subcontroller is instructed to add an amount of credits to a credit meter of the one or more credit meters 110 when the wagering outcome indicates a win for a player associated with the credit meter. In various embodiments, the metering subcontroller is instructed to deduct an amount of credits from the credit meter when the wagering outcome data indicates a loss for the player. At an end of a wagering session, the metering subcontroller 140 transfers credits off of the one or more credit meters 110 and out of the gambling hybrid game with a gambling integrated game gaming system by communicating outgoing credit data to the credit processing subcontroller 105. The credit processing subcontroller 105 uses the outgoing credit data to generate one or more credit output items using the one or more credit output devices 146.

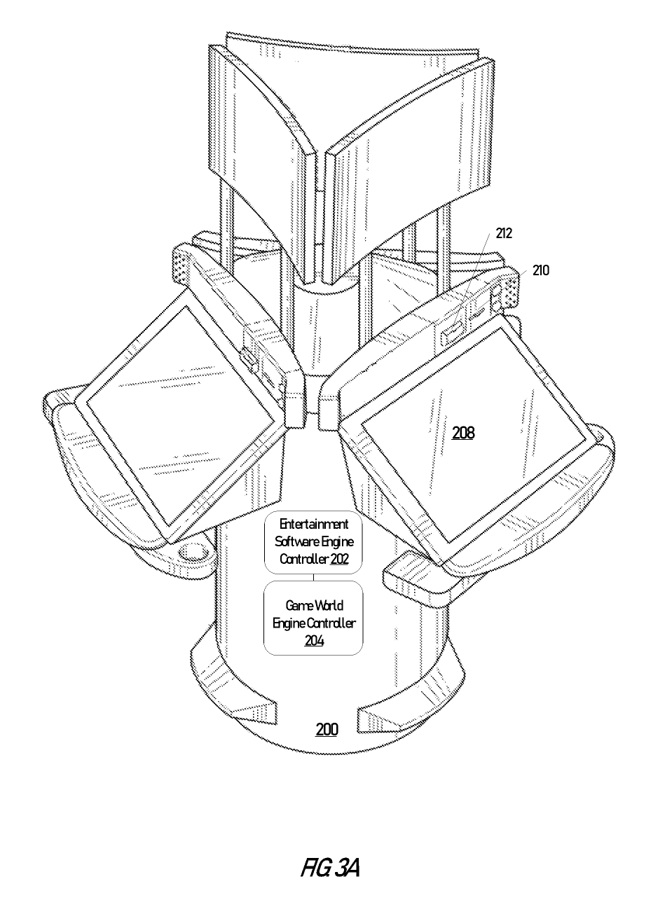

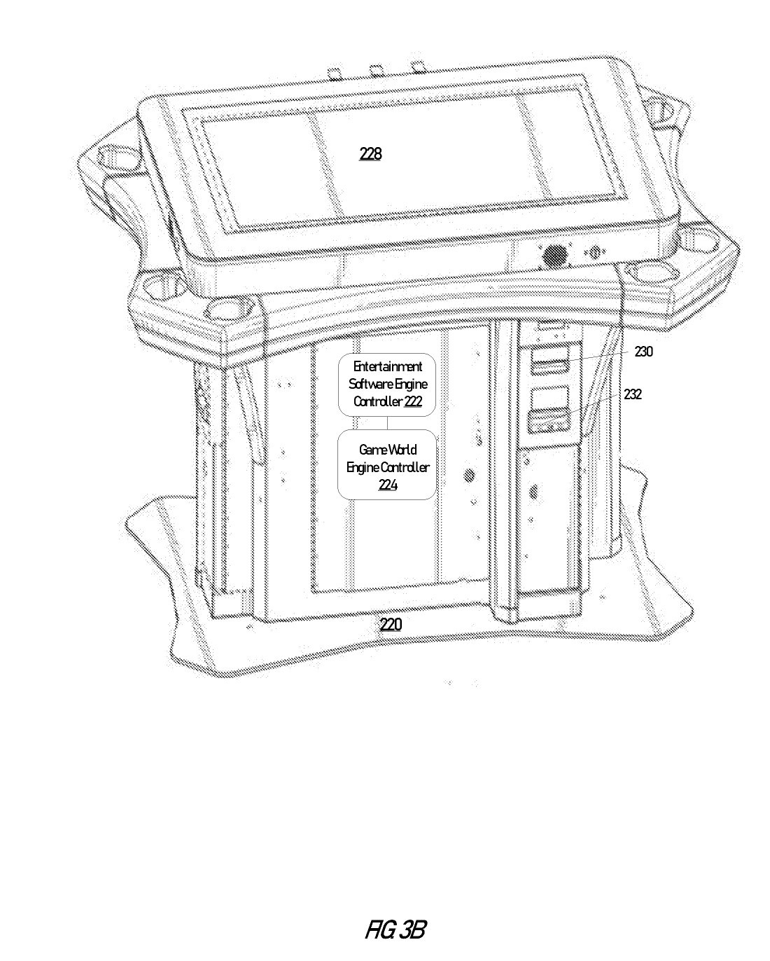

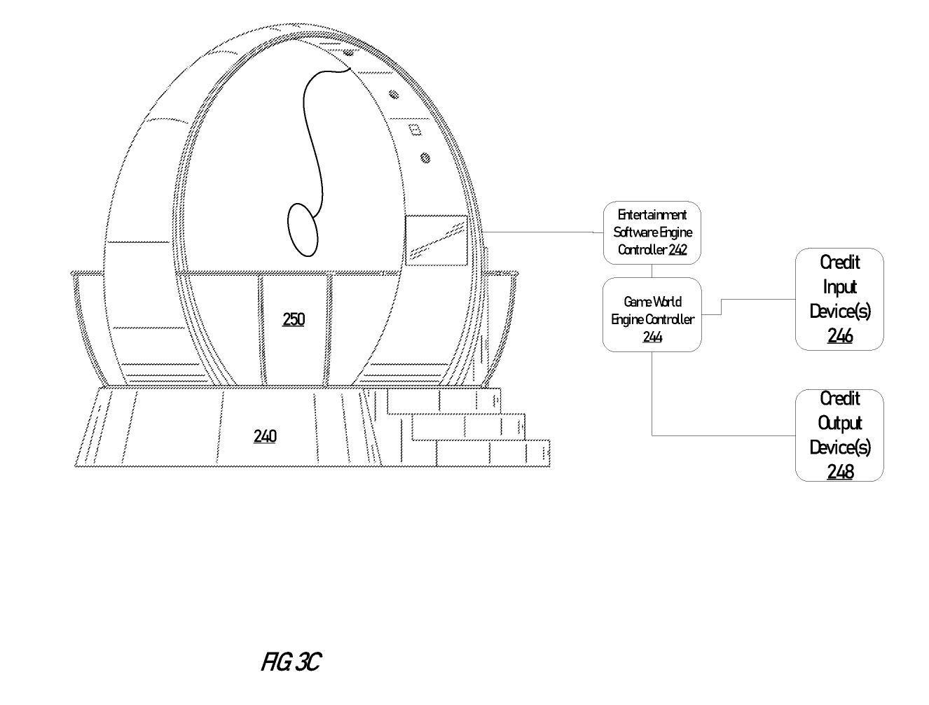

FIG. 3A is a diagram of an electronic gaming machine configuration of a gambling hybrid game with a gambling integrated game gaming system in accordance with various embodiments of the invention. Electronic gaming machine configurations of a gambling hybrid game with a gambling integrated game gaming system include, but are not limited to, electronic gaming machines such as slot machines, table games, video arcade consoles and the like. An electronic gaming machine configuration of a gambling hybrid game with a gambling integrated game gaming system 200 includes an entertainment software engine controller 202 as described herein and a game world engine controller 204 as described herein contained in an enclosure such as a housing, cabinet, casing or the like. The enclosure may further include one or more player accessible openings or surfaces that may be used to mount one or more player accessible user input devices and user output devices 208 as described herein, one or more player accessible credit input devices 210 and one or more player accessible credit output devices 212 as described herein. The entertainment software engine controller 202 communicates with the user input devices to detect player interactions with the gambling hybrid game with a gambling integrated game gaming system and commands and controls the user output devices to provide a user interface to one or more players of the gambling hybrid game with a gambling integrated game gaming system as described herein. The game world engine controller 204 communicates using a credit processing subcontroller to one or more player credit processing devices, such as credit input device 210 and credit output device 212 to transfer credits into and out of the gambling hybrid game with a gambling integrated game gaming system as described herein.

In various embodiments, the game world engine controller 204 uses a credit processing subcontroller operatively connected to one or more credit input devices 210 for generating incoming credit data from a credit input as described herein.

In various embodiments, the credit processing subcontroller is operatively connected to the one or more credit output devices 212 for generating a credit output based on outgoing credit data communicated from the game world engine controller 204 as described herein.

In some embodiments, the credit processing subcontroller is operatively connected to, and communicates with, a TITO system (not shown) or the like to determine incoming credit data representing amounts of credits to be transferred into the gambling hybrid game with a gambling integrated game gaming system 200 and to generate outgoing credit data representing amounts of credits to be transferred out of the gambling hybrid game with a gambling integrated game gaming system 200 as described herein.

In various embodiments, the credit processing subcontroller provides an interface to an electronic payment system (not shown) such an electronic wallet or the like. The electronic payment system provides credit account data that is used for generating incoming credit data as a credit input and outgoing credit data as a credit output as described herein.

In some embodiments, the game world engine controller 204 is operatively connected to a central determination controller (not shown) as described herein.

In various embodiments, the game world engine controller 204 may be operatively connected to a progressive controller along (not shown) with one or more other game world engine controllers of one or more other gambling hybrid game with a gambling integrated game gaming systems as described herein.

FIG. 3B is a diagram of multiplayer or multiplayer electronic gaming machine configuration of a gambling hybrid game with a gambling integrated game gaming system in accordance with various embodiments of the invention. Types of a multiplayer or multiplayer electronic gaming machine configuration a gambling hybrid game with a gambling integrated game gaming system include, but are not limited to, multiplayer or multiplayer electronic gaming machines, multiplayer or multiplayer slot machines, multiplayer or multiplayer table gaming devices, multiplayer or multiplayer video arcade consoles and the like. A multiplayer or multiplayer electronic gaming machine configuration of a gambling hybrid game with a gambling integrated game gaming system 220 includes an entertainment software engine controller 222 as described herein and a game world engine controller 224 as described herein contained in an enclosure such as a housing, cabinet, casing or the like. The enclosure may further include one or more player accessible openings or surfaces that may be used to mount one or more player accessible user input devices and user output devices 228 as described herein, one or more player accessible credit input devices 230 as described herein and one or more player accessible credit output devices 232 as described herein.

In some embodiments, two or more sets of credit input devices and credit output devices are provided so that each player of the multiplayer or multiplayer electronic gaming machine configuration of a gambling hybrid game with a gambling integrated game gaming system 220 can have an associated set of credit input devices and credit output devices.

The entertainment software engine controller 222 communicates with the user input devices to detect player interactions with the gambling hybrid game with a gambling integrated game gaming system and commands and controls the user output devices to provide a user interface to one or more players of the gambling hybrid game with a gambling integrated game gaming system as described herein. The game world engine controller 224 communicates with the credit processing subcontroller 226 or player credit processing devices 230 and 232 to transfer credits into and out of the gambling hybrid game with a gambling integrated game gaming system as described herein.

In various embodiments, the game world engine controller 224 uses a credit processing subcontroller operatively connected to one or more credit input devices 230 for generating incoming credit data from a credit input as described herein.

In various embodiments, the credit processing subcontroller is operatively connected to the one or more credit output devices 232 for generating a credit output based on outgoing credit data communicated from the game world engine controller 224 as described herein.

In some embodiments, the credit processing subcontroller is operatively connected to, and communicates with, a TITO system (not shown) or the like to determine incoming credit data representing amounts of credits to be transferred into the gambling hybrid game with a gambling integrated game gaming system 220 and to generate outgoing credit data representing amounts of credits to be transferred out of the gambling hybrid game with a gambling integrated game gaming system 220 as described herein.

In various embodiments, the credit processing subcontroller provides an interface to an electronic payment system (not shown) such an electronic wallet or the like. The electronic payment system provides credit account data that is used for generating incoming credit data as a credit input and outgoing credit data as a credit output as described herein.

In some embodiments, the game world engine controller 224 is operatively connected to a central determination controller (not shown) as described herein.

In various embodiments, the game world engine controller 224 may be operatively connected to a progressive controller along (not shown) with one or more other game world engine controllers of one or more other gambling hybrid game with a gambling integrated game gaming systems as described herein.

FIG. 3C is a diagram of virtual reality gaming machine configuration of a gambling hybrid game with a gambling integrated game gaming system in accordance with various embodiments of the invention. Types of a virtual reality gaming machine configuration of a gambling hybrid game with a gambling integrated game gaming system include, but are not limited to, virtual reality gaming machines, virtual reality slot machines, virtual reality gaming devices, virtual reality arcade consoles and the like. A virtual reality gaming machine 240 configuration of a gambling hybrid game with a gambling integrated game gaming system includes an entertainment software engine controller 242, and a game world engine controller 244 contained in an enclosure such as a housing, cabinet, casing or the like. The enclosure may further include one or more player accessible openings or surfaces that may be used to mount one or more player accessible user input devices and user output devices, one or more player accessible credit input devices 246 and one or more player accessible credit output devices 248.

A virtual reality gaming machine configuration 240 of a gambling hybrid game with a gambling integrated game gaming system further includes a player area 250 having virtual reality sensors for sensing player interactions and/or player movements within the player area, a player headset having a stereoscopic visual display for display of a stereoscopic interactive user interface to a player, headphones for presenting a stereophonic sound presentation to a player, and one or more subwoofers for providing a hepatic or low frequency auditory presentation to the player.

The entertainment software engine controller communicates with the user input devices to detect player interactions with the virtual reality gambling hybrid game with a gambling integrated game gaming system and commands and controls the user output devices to provide a user interface to one or more players of the virtual reality gambling hybrid game with a gambling integrated game gaming system as described herein. The game world engine controller communicates with the credit processing subcontroller or player credit processing devices and to transfer credits into and out of the gambling hybrid game with a gambling integrated game gaming system as described herein.

In many embodiments, the game world engine controller is further connected to one or more side betting terminals that enable spectators of a player using the virtual reality gambling hybrid game with a gambling integrated game gaming system to make side bets based on the performance of the player.

In various embodiments, the game world engine controller uses a credit processing subcontroller operatively connected to one or more credit input devices for generating incoming credit data from a credit input as described herein.

In various embodiments, the credit processing subcontroller is operatively connected to the one or more credit output devices for generating a credit output based on outgoing credit data communicated from the game world engine controller as described herein.

In some embodiments, the credit processing subcontroller is operatively connected to, and communicates with, a TITO system (not shown) or the like to determine incoming credit data representing amounts of credits to be transferred into the gambling hybrid game with a gambling integrated game gaming system 240 and to generate outgoing credit data representing amounts of credits to be transferred out of the gambling hybrid game with a gambling integrated game gaming system 240 as described herein.

In various embodiments, the credit processing subcontroller provides an interface to an electronic payment system (not shown) such an electronic wallet or the like. The electronic payment system provides credit account data that is used for generating incoming credit data as a credit input and outgoing credit data as a credit output as described herein.

In some embodiments, the game world engine controller is operatively connected to a central determination controller (not shown) as described herein.

In various embodiments, the game world engine controller may be operatively connected to a progressive controller along (not shown) with one or more other game world engine controllers of one or more other gambling hybrid game with a gambling integrated game gaming systems as described herein.

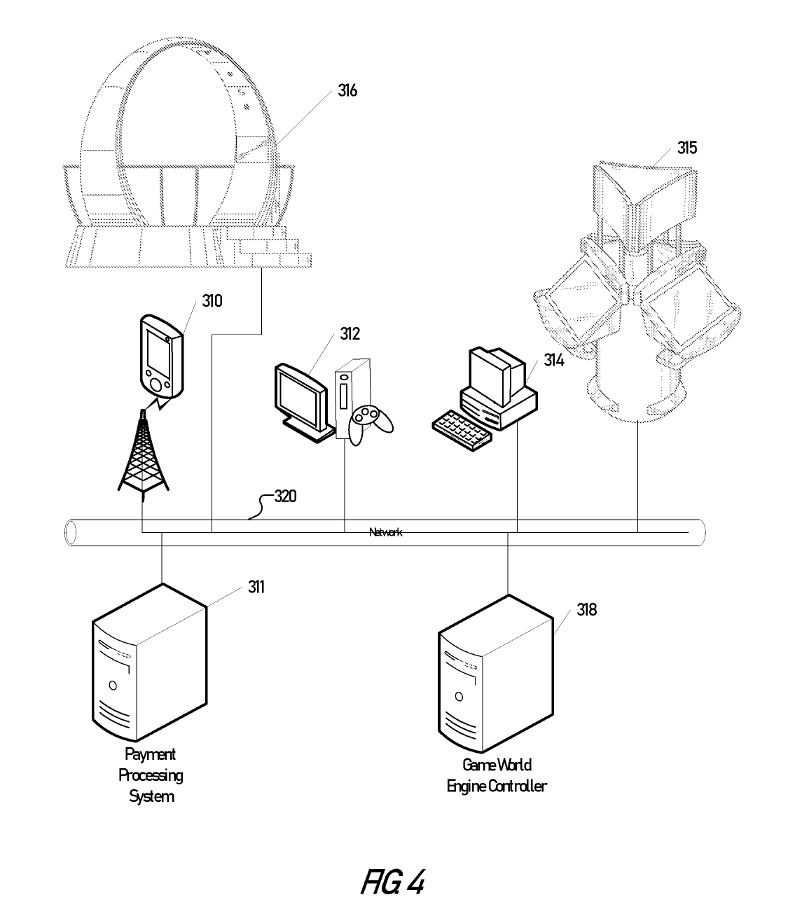

FIG. 4 is a diagram of distributed gambling hybrid game with a gambling integrated game gaming systems in accordance with various embodiments of the invention. An entertainment software engine controller in a distributed gambling hybrid game with a gambling integrated game gaming system may be constructed from or configured using any processing device having sufficient processing and communication capabilities to perform the processes of an entertainment software engine controller in accordance with various embodiments of the invention. In some embodiments, the construction or configuration of the entertainment software engine controller may be achieved through the use of an entertainment game control interface and/or through the use of an entertainment game.

In various embodiments, an entertainment game may require extensive processing resources from an entertainment software engine controller leaving few processing resources for the functions performed by a game world engine controller and/or a real world engine subcontroller. By virtue of the architecture described herein, processing loads may be distributed across multiple devices so that operations of the entertainment software engine controller may be dedicated to the entertainment game and the processes of the game world engine controller and/or real world engine subcontroller are not burdened by the requirements of the entertainment game.

In many embodiments, a gambling hybrid game with a gambling integrated game gaming system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like.

In some embodiments, one or more components of a gambling hybrid game with a gambling integrated game gaming system are distributed in close proximity to each other and communicate using a local area network and/or a communication bus. In several embodiments, an entertainment software engine controller and a game world engine controller of a gambling hybrid game with a gambling integrated game gaming system are in a common location and communicate with an external real world engine subcontroller. In some embodiments, a game world engine controller and a real world engine subcontroller of a gambling hybrid game with a gambling integrated game gaming system are in a common location and communicate with an external entertainment software engine controller. In many embodiments, an entertainment software engine controller, a game world engine controller, and a real world engine subcontroller of a gambling hybrid game with a gambling integrated game gaming system are located in a common location. In some embodiments, a session subcontroller is located in a common location with a game world engine controller and/or a real world engine subcontroller.

In various embodiments, these multiple devices can be constructed from or configured using a single device or a plurality of devices so that a gambling hybrid game with a gambling integrated game gaming system is executed as a system in a virtualized space such as, but not limited to, where a game world engine controller is a large scale centralized server in a cloud networking environment operatively connected to widely distributed entertainment software engine controllers via a wide area network such as the Internet or a local area network. In embodiments, the components of a gambling hybrid game with a gambling integrated game gaming system may communicate using a networking protocol or other type of device-to-device communications protocol.

In some embodiments, a gambling hybrid game with a gambling integrated game gaming system is deployed over a local area network or a wide area network in a mobile configuration. A mobile configuration of a gambling hybrid game with a gambling integrated game gaming system is useful for deployment over wireless communication network, such as a wireless local area network or a wireless telecommunications network. A mobile configuration of a gambling hybrid game with a gambling integrated game gaming system includes an entertainment software engine controller operatively connected by a wireless network to a game world engine controller and a real world engine subcontroller.

In numerous embodiments, an entertainment game server provides a host for managing head-to-head play operating over a network of entertainment software engine controllers connected to the entertainment game server using a communication link. The entertainment game server provides an environment where players can compete directly with one another and interact with other players.

In some embodiments, an entertainment software engine controller may be constructed from or configured using an electronic gaming machine 315, such as a slot machine or the like. The electronic gaming machine 315 may be physically located in various types of gaming establishments.

In many embodiments, an entertainment software engine controller may be constructed from or configured using a portable device 310. The portable device 310 is a device that may wirelessly connect to a network. Examples of portable devices include, but are not limited to, a tablet computer, a personal digital assistant, and a smartphone.

Some gambling hybrid game with a gambling integrated game gaming systems in accordance with many embodiments of the invention can be distributed across a plurality of devices in various configurations. One or more entertainment software engine controllers of a distributed gambling hybrid game with a gambling integrated game gaming system, such as but not limited to, a mobile or wireless device 310, a gaming console 312, a personal computer 314, an electronic gaming machine 315, and a virtual reality gaming machine 316 are operatively connected with a game world engine controller 318 of a distributed gambling hybrid game with a gambling integrated game gaming system using a communication link 320. Communication link 320 is a communications link that allows processing systems to communicate with each other and to share data. Embodiments of a communication link include, but are not limited to: a wired or wireless interdevice communication link; a serial or parallel interdevice communication bus; a wired or wireless network such as a Local Area Network (LAN), a Wide Area Network (WAN), or the link; or a wired or wireless communication network such as a wireless telecommunications network or plain old telephone system (POTS). In some embodiments, one or more processes of an entertainment software engine controller and a game world engine controller as described herein are executed on the individual entertainment software engine controllers 310, 312, 314, 315 and 316 while one or more processes of a game world engine controller as described herein can be executed by the game world engine controller 318.

In many embodiments, a distributed gambling hybrid game with a gambling integrated game gaming system and may be operatively connected using a communication link to a session controller (not shown), that performs the processes of a session controller as described herein.

In several embodiments, a distributed gambling hybrid game with a gambling integrated game gaming system and may be operatively connected using a communication link to credit processing system 311, that performs the processes of one or more credit processing systems as described herein.

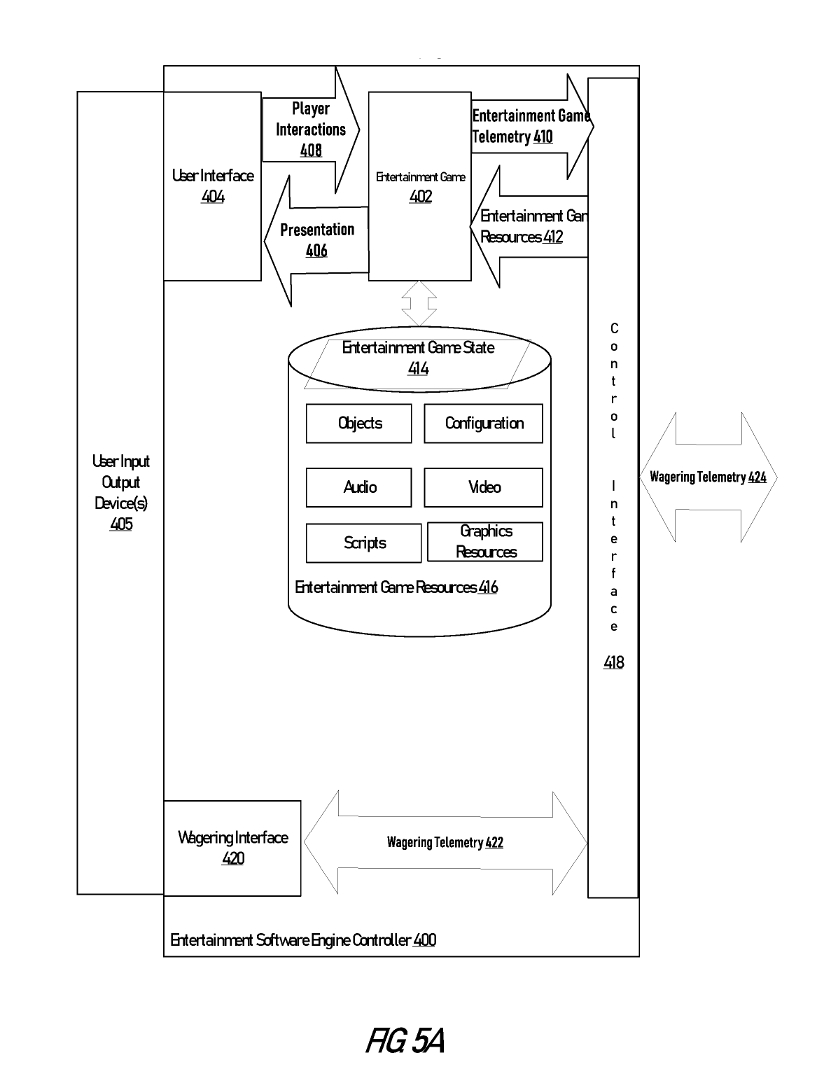

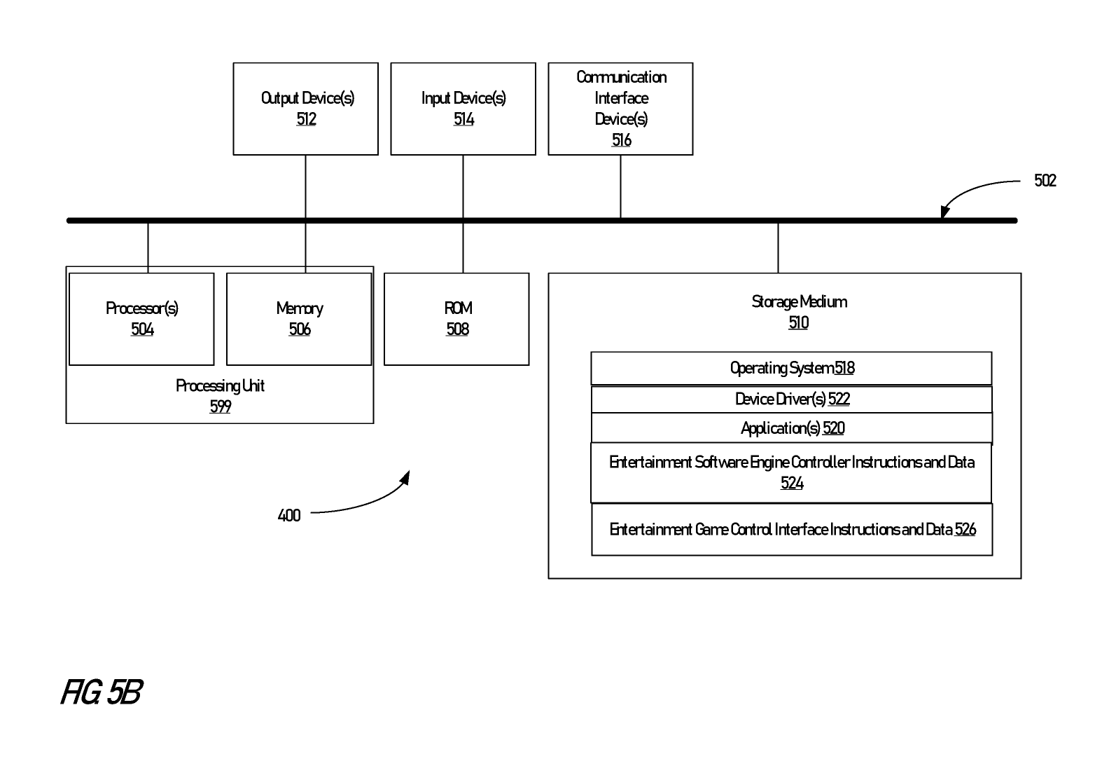

FIGS. 5A and 5B are architecture diagrams of an entertainment software engine controller in accordance with various embodiments of the invention. Referring now to FIG. 5A, an entertainment software engine controller 400 provides an execution environment for an entertainment game 402 of a gambling hybrid game with a gambling integrated game gaming system. In several embodiments, an entertainment software engine controller 400 of a gambling hybrid game with a gambling integrated game gaming system provides an entertainment game 402 that generates an entertainment game interface 404 for interaction with by one or more players. The entertainment game 402 generates an interactive user interface 406 that is presented to the player through the entertainment game interface 404 using one or more user input and output devices 405. The interactive user interface 406 may include audio features, visual features or tactile features, or any combination of these features. In various embodiments, the entertainment game interface 404 utilizes one or more user interface input and output devices 405 so that a player can interact with the interactive user interface 406. In various embodiments, user input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user output devices include, but are not limited to: audio output devices such as speakers, headphones, earbuds, and the like; visual output devices such as lights, video displays and the like; and tactile devices such as rumble pads, hepatic touch screens, buttons, keys and the like. The player's interactions 408 are included by the entertainment game 402 in entertainment game telemetry data 410 that is communicated by entertainment software engine controller 400 as part of hybrid gaming wagering telemetry data 424 to various other components of a gambling hybrid game with a gambling integrated game gaming system as described herein. The entertainment game 402 receives entertainment game resources 412 communicated as part of hybrid gaming wagering telemetry data 424 from various other components of a gambling hybrid game with a gambling integrated game gaming system as described herein. In some embodiments, the hybrid gaming wagering telemetry data 424 may include player interactions with objects of the entertainment game presented to the player by the entertainment game 402.

In some embodiments, various components of the entertainment game 402 can read data from an entertainment game state 414 in order to provide one or more features of the entertainment game. In various embodiments, components of the entertainment game 402 can include, but are not limited to: a physics engine; a rules engine; an audio engine; a graphics engine and the like. The physics engine is used to simulate physical interactions between interactive elements in the entertainment game 402. The rules engine implements the rules of the entertainment game and a random number generator that may be used for influencing or determining certain variables and/or outcomes to provide a randomizing influence on the operations of the entertainment game. The graphics engine is used to generate a visual representation of the entertainment game state to the player. The audio engine is used to generate an audio representation of the entertainment game state to the player.

During operation, the entertainment game reads and writes entertainment game resources 416 stored on a data store of the entertainment software engine controller 400. The entertainment game resources 416 may include objects having graphics and/or control logic used to provide interactive elements of the entertainment game. In various embodiments, the resources may also include, but are not limited to, video files that are used to generate a portion of the interactive user interface 406; audio files used to generate music, sound effects, etc. within the entertainment game; configuration files used to configure the features of the entertainment game; scripts or other types of control code used to provide various features of the entertainment game; and graphics resources such as textures, objects, etc. that are used by a graphics engine to render objects displayed in an entertainment game.

In operation, components of the entertainment game 402 read portions of the entertainment game state 414 and generate the interactive user interface 406 for the player that is presented to the player using the user interface 404. The player perceives the interactive user interface and provides player interactions 408 using the user input devices. The corresponding player interactions are detected as player actions or inputs by various components of the entertainment game 402. The entertainment game 402 translates the player actions into interactions with the interactive elements of the entertainment game. Components of the entertainment game use the player interactions with the interactive elements of the entertainment game and the entertainment game state 414 to update the entertainment game state 414 and update the interactive user interface 406 presented to the player. The process loops continuously while the player interacts with the entertainment game of the gambling hybrid game with a gambling integrated game gaming system.

The entertainment software engine controller 400 provides one or more interfaces 418 between the entertainment software engine controller 400 and other components of a gambling hybrid game with a gambling integrated game gaming system, such as, but not limited to, a game world engine controller. The entertainment software engine controller 400 and the other gambling hybrid game with a gambling integrated game gaming system components communicate with each other using the interface. The interface may be used to pass various types of data, and to communicate and receive messages, status data, commands and the like. In certain embodiments, the entertainment software engine controller 400 and a game world engine controller communicate wagering telemetry data 424. In some embodiments, the communications include requests by the game world engine controller that the entertainment software engine controller 400 update the entertainment game state 414 using data provided by the game world engine controller.

In many embodiments, communications between a game world engine controller and the entertainment software engine controller 400 includes a request that the entertainment software engine controller 400 update one or more resources 416 using data provided by the game world engine controller. In a number of embodiments, the entertainment software engine controller 400 provides all or a portion of the entertainment game state to the game world engine controller. In some embodiments, the entertainment software engine controller 400 may also provide data about one or more of the entertainment game resources 416 to the game world engine controller. In some embodiments, the communication includes player interactions that the entertainment software engine controller 400 communicates to the game world engine controller. The player interactions may be low level player interactions with the user interface 404, such as manipulation of an input device, or may be high level player interactions with game world objects as detected by the entertainment game. The player interactions may also include resultant actions such as modifications to the entertainment game state 414 or game resources 416 resulting from the player's interactions taken in the gambling hybrid game with a gambling integrated game gaming system entertainment game. In some embodiments, player interactions include, but are not limited to, actions taken by entities such as non-player characters (NPCs) of the entertainment game that act on behalf of or under the control of the player.

In various embodiments, the entertainment game resources 412 include entertainment game resources used by the entertainment game 402 to generate an interactive user interface of a hybrid gaming wagering process presented to a player and to detect the player's interaction with the interactive user interface. In many embodiments, data of the entertainment game resources 412 includes data of one or more gambling game outcomes as described herein.

In some embodiments, the entertainment software engine controller 400 includes a gambling game user interface 420 used to provide and receive wagering telemetry data 422 to and from the player. The gambling hybrid game with a gambling integrated game gaming system telemetry data 422 from the gambling hybrid game with a gambling integrated game gaming system includes, but is not limited to, data used by the player to configure a wager, data used to communicate as part of hybrid gaming wagering telemetry data 424 a state of a hybrid gaming wagering process, and data about a wagering outcome.

In some embodiments, the entertainment software engine controller includes one or more sensors (not shown). Such sensors may include, but are not limited to, physiological sensors that monitor the physiology of the player, environmental sensors that monitor the physical environment of the entertainment software engine controller, accelerometers that monitor changes in motion of the entertainment software engine controller, and location sensors that monitor the location of the entertainment software engine controller such as global positioning sensors (GPSs). The entertainment software engine controller 400 communicates sensor telemetry data to one or more components of the gambling hybrid game with a gambling integrated game gaming system.

Referring now to FIG. 5B, entertainment software engine controller 400 includes a bus 502 that provides an interface for one or more processors 504, random access memory (RAM) 506, read only memory (ROM) 508, machine-readable storage medium 510, one or more user output devices 512 as described herein, one or more user input devices 514 as described herein, and one or more communication interface devices 516 for implementing one or more interfaces as described herein.

The one or more processors 504 may take many forms, such as, but not limited to: a central processing unit (CPU); a multi-processor unit (MPU); an ARM processor; a controller; a programmable logic device; or the like.

In the example embodiment, the one or more processors 504 and the random access memory (RAM) 506 form an entertainment software engine controller processing unit 599. In some embodiments, the entertainment software engine controller processing unit includes one or more processors operatively connected to one or more of a RAM, ROM, and machine-readable storage medium; the one or more processors of the entertainment software engine controller processing unit receive instructions stored by the one or more of a RAM, ROM, and machine-readable storage medium via a bus; and the one or more processors execute the received instructions. In some embodiments, the entertainment software engine controller processing unit is an ASIC (Application-Specific Integrated Circuit). In some embodiments, the entertainment software engine controller processing unit is a SoC (System-on-Chip).

The one or more communication interface devices 516 provide one or more wired or wireless interfaces for communicating data and commands between the entertainment software engine controller 400 and other devices that may be included in a gambling hybrid game with a gambling integrated game gaming system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface, a cellular or satellite telephone network interface; and the like.

The machine-readable storage medium 510 stores machine-executable instructions for various components of the entertainment software engine controller, such as but not limited to: an operating system 518; one or more device drivers 522; one or more application programs 520 including but not limited to an entertainment game; and gambling hybrid game with a gambling integrated game gaming system entertainment software engine controller instructions and data 524 for use by the one or more processors 504 to provide the features of an entertainment software engine controller as described herein. In some embodiments, the machine-executable instructions further include entertainment game control interface/entertainment game control interface instructions and data 526 for use by the one or more processors 504 to provide the features of an entertainment game control interface/entertainment game control interface as described herein.

In various embodiments, the machine-readable storage medium 510 is one of a (or a combination of two or more of) a hard drive, a flash drive, a DVD, a CD, a flash storage, a solid state drive, a ROM, an EIEPROM, and the like.

In operation, the machine-executable instructions are loaded into memory 506 from the machine-readable storage medium 510, the ROM 508 or any other storage location. The respective machine-executable instructions are accessed by the one or more processors 504 via the bus 502, and then executed by the one or more processors 504. Data used by the one or more processors 504 are also stored in memory 506, and the one or more processors 504 access such data during execution of the machine-executable instructions. Execution of the machine-executable instructions causes the one or more processors 504 to control the entertainment software engine controller 400 to provide the features of a gambling hybrid game with a gambling integrated game gaming system entertainment software engine controller as described herein

Although the entertainment software engine controller is described herein as being constructed from or configured using one or more processors and instructions stored and executed by hardware components, the entertainment software engine controller can be constructed from or configured using only hardware components in accordance with other embodiments. In addition, although the storage medium 510 is described as being operatively connected to the one or more processors through a bus, those skilled in the art of entertainment software engine controllers will understand that the storage medium can include removable media such as, but not limited to, a USB memory device, an optical CD ROM, magnetic media such as tape and disks. In some embodiments, the storage medium 510 can be accessed by the one or more processors 504 through one of the communication interface devices 516 or using a communication link. Furthermore, any of the user input devices or user output devices can be operatively connected to the one or more processors 504 via one of the communication interface devices 516 or using a communication link.

In some embodiments, the entertainment software engine controller 400 can be distributed across a plurality of different devices. In many embodiments, an entertainment software engine controller of a gambling hybrid game with a gambling integrated game gaming system includes an entertainment game server operatively connected to an interactive client using a communication link. The entertainment game server and entertainment game client cooperate to provide the features of an entertainment software engine controller as described herein.

In various embodiments, the entertainment software engine controller 400 may be used to construct other components of a gambling hybrid game with a gambling integrated game gaming system as described herein.

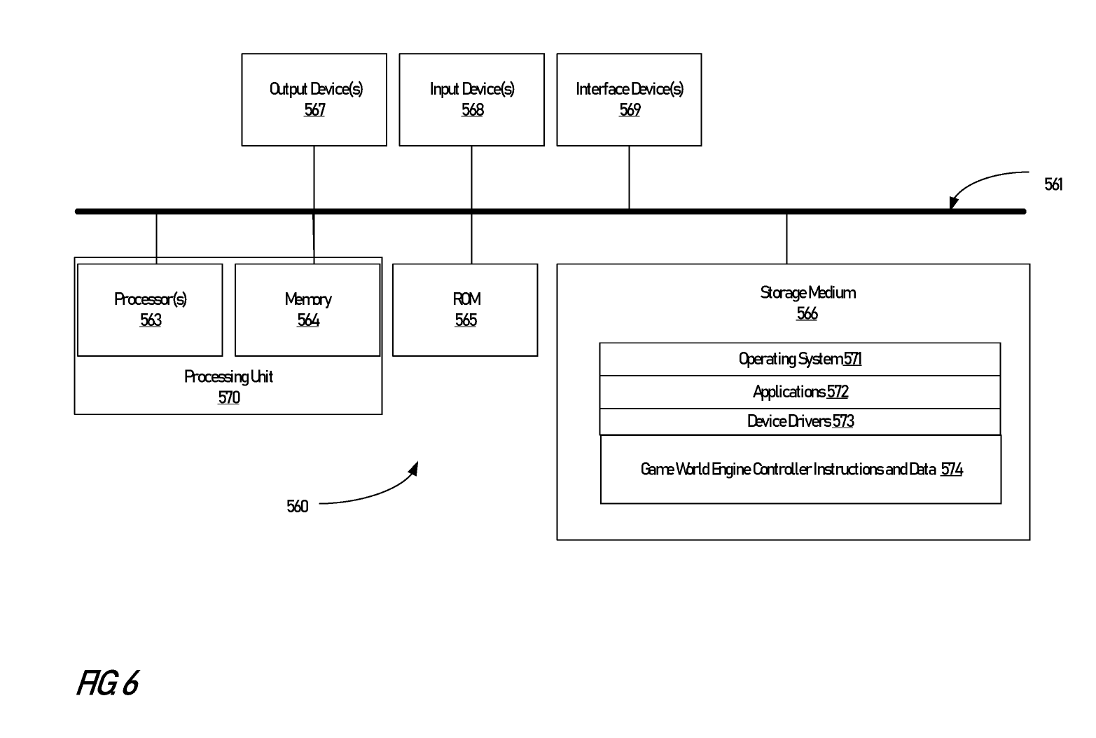

FIG. 6 is an architecture diagram of a game world engine controller, suitable for use as game world engine controller 104 of FIG. 2, of a gambling hybrid game with a gambling integrated game gaming system in accordance with various embodiments of the invention. A game world engine controller may be constructed from or configured using one or more processing devices that perform the operations of the game world engine controller. In many embodiments, a game world engine controller can be constructed from or configured using various types of processing devices including, but not limited to, a mobile device such as a smartphone, a personal digital assistant, a wireless device such as a tablet computer or the like, an electronic gaming machine such as a slot machine, a personal computer, a gaming console, a set-top box, a computing device, a controller, a server, or the like.

Game world controller 560 includes a bus 561 providing an interface for one or more processors 563, random access memory (RAM) 564, read only memory (ROM) 565, machine-readable storage medium 566, one or more user output devices 567 as described herein, one or more user input devices 568 as described herein, and one or more communication interface and/or network interface devices 569 used to implement one or more interfaces as described herein.

The one or more processors 563 may take many forms, such as, but not limited to: a central processing unit (CPU); a multi-processor unit (MPU); an ARM processor; a programmable logic device; or the like.

In the example embodiment, the one or more processors 563 and the random access memory (RAM) 564 form a game world engine controller processing unit 570. In some embodiments, the game world engine controller processing unit includes one or more processors operatively connected to one or more of a RAM, ROM, and machine-readable storage medium; the one or more processors of the game world engine controller processing unit receive instructions stored by the one or more of a RAM, ROM, and machine-readable storage medium via a bus; and the one or more processors execute the received instructions. In some embodiments, the game world engine controller processing unit is an ASIC (Application-Specific Integrated Circuit). In some embodiments, the game world engine controller processing unit is a SoC (System-on-Chip).

The one or more communication interface and/or network interface devices 569 provide one or more wired or wireless interfaces for exchanging data and commands between the game world engine controller 560 and other devices that may be included in a gambling hybrid game with a gambling integrated game gaming system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium 566 stores machine-executable instructions for various components of the game world engine controller 560 such as, but not limited to: an operating system 571; one or more applications 572; one or more device drivers 573; and gambling hybrid game with a gambling integrated game gaming system game world engine controller instructions and data 574 for use by the one or more processors 563 to provide the features of a game world engine controller as described herein.

In various embodiments, the machine-readable storage medium 566 is one of a (or a combination of two or more of) a hard drive, a flash drive, a DVD, a CD, a flash storage, a solid state drive, a ROM, an EIEPROM, and the like.

In operation, the machine-executable instructions are loaded into memory 564 from the machine-readable storage medium 566, the ROM 565 or any other storage location. The respective machine-executable instructions are accessed by the one or more processors 563 via the bus 561, and then executed by the one or more processors 563. Data used by the one or more processors 563 are also stored in memory 564, and the one or more processors 563 access such data during execution of the machine-executable instructions. Execution of the machine-executable instructions causes the one or more processors 563 to control the game world engine controller 560 to provide the features of a gambling hybrid game with a gambling integrated game gaming system game world engine controller as described herein.

Although the game world engine controller 560 is described herein as being constructed from or configured using one or more processors and instructions stored and executed by hardware components, the game world engine controller can be composed of only hardware components in accordance with other embodiments. In addition, although the storage medium 566 is described as being operatively connected to the one or more processors through a bus, those skilled in the art of game world engine controllers will understand that the storage medium can include removable media such as, but not limited to, a USB memory device, an optical CD ROM, magnetic media such as tape and disks. Also, in some embodiments, the storage medium 566 may be accessed by processor 563 through one of the interfaces or using a communication link. Furthermore, any of the user input devices or user output devices may be operatively connected to the one or more processors 563 via one of the interfaces or using a communication link.

In various embodiments, the game world engine controller 560 may be used to construct other components of a gambling hybrid game with a gambling integrated game gaming system as described herein.

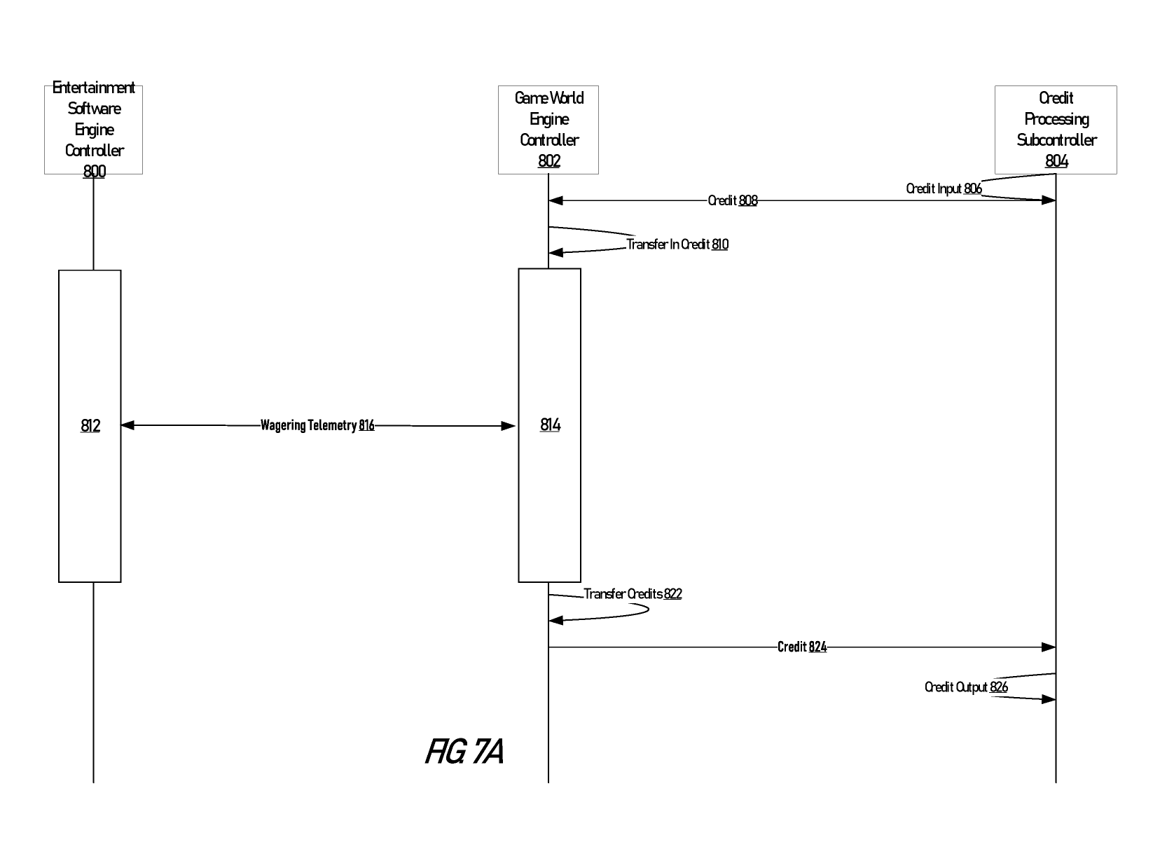

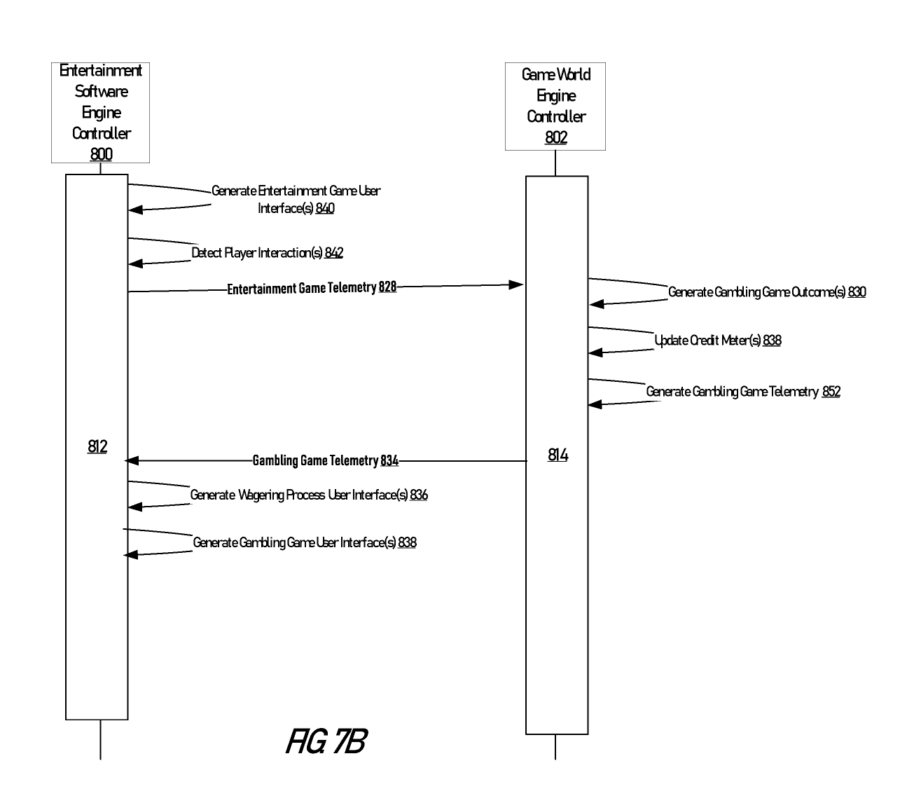

Referring now to FIG. 7A, in some embodiments, at a beginning of the wagering session, the process includes a credit input 806 to the gambling hybrid game with a gambling integrated game gaming system with a game world engine controller 802 communicating with a credit processing subcontroller 804 to receive incoming credit data 808. The game world engine controller 802 uses the incoming credit data to transfer 810 credits onto one or more player credit meters associated with one or more players of the gambling hybrid game with a gambling integrated game gaming system, thus transferring credits into the gambling hybrid game with a gambling integrated game gaming system and on to the one or more player credit meters.

During the hybrid gaming wagering process 812 and 814, an entertainment software engine controller 800 and the game world engine controller 802 communicate hybrid gaming wagering telemetry data 816 used by the controllers to implement the hybrid gaming wagering process. The data communicated includes data of, but is not limited to, entertainment game telemetry, entertainment game resources, gambling game telemetry and/or gambling game outcomes of the hybrid gaming wagering process as described herein.

In many embodiments, upon determining that a wagering session is completed, such as by receiving a cashout communication from the one or more players of the gambling hybrid game with a gambling integrated game gaming system, the game world engine controller 802 transfers 822 credits off of the one or more player credit meters, generates outgoing credit data 824 on the basis of the credits transferred off of the one or more player credit meters, and communicates the outgoing credit data 824 to the credit processing subcontroller 804. The credit processing subcontroller 804 receives the outgoing credit data 824 and generates 826 a credit output as described herein, thus transferring credits off of the one or more player credit meters and out of the gambling hybrid game with a gambling integrated game gaming system.

Referring now to FIG. 7B, in slightly more detail, the entertainment software engine controller 800 generates 840 an interactive entertainment game user interface and detects 842 one or more player interactions of the one or more players with interactive elements of the interactive user interface.

The entertainment software engine controller 800 communicates entertainment game telemetry data 828 to the game world engine controller 802. The interactive hybrid gaming wagering telemetry data 828 includes, but is not limited to, data of one or more player interactions detected by the entertainment software engine controller 800 and/or one or more entertainment game events.

The game world engine controller 802 receives the entertainment game telemetry data 828. Upon determination by the game world engine controller 802 that the entertainment game telemetry data indicates a gambling game outcome of the hybrid gaming wagering process is to be generated in accordance with a state of the hybrid gaming wagering process, the game world engine controller 802 generates 830 one or more gambling game outcomes. In the case that one or more of the gambling game outcomes is generated in association with a commitment of an amount of credits to a wager, the game world engine controller 802 updates 838 one or more credit meters to reflect the wager commitment. The game world engine controller 802 generates 852 gambling game telemetry data 834 including one or more gambling game outcomes and communicates the gambling game telemetry data 834 to the entertainment software engine controller 800.

The entertainment software engine controller 800 receives the gambling game telemetry data 834 from the game world engine controller 802 and uses the gambling game telemetry data to generate 836 a wagering process user interface and generate 838 a gambling game user interface of the entertainment software engine controller 800.

In some embodiments, at a beginning of the wagering session, the process includes a GWC input to the gambling hybrid game with a gambling integrated game gaming system with the game world engine controller 802 communicating with the credit processing subcontroller 803 to receive incoming GWC data. The game world engine controller 802 uses the incoming GWC data to transfer GWC onto one or more GWC meters associated with one or more players of the gambling hybrid game with a gambling integrated game gaming system, thus transferring GWC into the gambling hybrid game with a gambling integrated game gaming system and on to the one or more GWC meters. The game world engine controller 802 uses interactive state data of an entertainment game to generate an amount of GWC to award to a player based on the player's achievement of one or more objectives of the entertainment game. Upon determining that the wagering session is completed, such as by receiving a cashout communication from one or more players of the gambling hybrid game with a gambling integrated game gaming system, the game world engine controller 802 transfers GWC off of the one or more GWC meters, generates outgoing GWC data on the basis of the GWC transferred off of the one or more GWC meters, and communicates the outgoing GWC data to the credit processing subcontroller 803. The credit processing subcontroller receives the outgoing GWC data and generates an GWC output as described herein, thus transferring GWC off of the one or more GWC meters and out of the gambling hybrid game with a gambling integrated game gaming system.

In accordance with many embodiments of the invention, a gambling hybrid game provides an entertainment game and a gambling game. A wide array of entertainment games include explicit random events that are observable to the game's player(s) and often initiated by a player. Random events can include, but are not limited to, the drawing of cards, the rolling of a die, and the use of a spinner. These explicit random events can be singular or multiple, operating in parallel or in serial. For example, Monopole provided by Hasbro Inc. of Pawtucket, R.I. is played by each player rolling a pair of dice at the onset of each turn to move a game piece around the board (singular per turn, and serially between players). In Rise provided by Hasbro Inc. of Pawtucket, R.I., two players roll dice simultaneously to establish the outcome of a battle, and the players continue to roll dice until the battle is resolved (parallel dice rolls occurring multiple times). In Scrabble® provided by Hasbro Inc. of Pawtucket, R.I., a player draws tiles at random from a pool of tiles. In War, players draw randomly ordered cards from a deck of cards and compare those cards each turn. These random events are typically initiated by a player as part of a player's turn and can drive actions such as the movement of a player piece around a board (e.g. Monopoly®), the resolution of a battle between players (e.g. Risk®), establishing whether a character successfully deploys a specific skill (e.g. Dungeons and Dragons®), etc. Although the above examples discussed are board games, the same principle can be applied in computerized versions of these games.

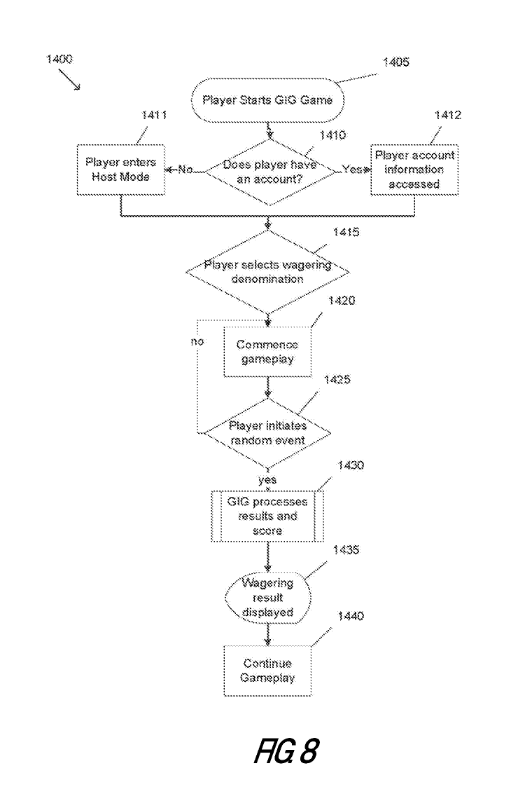

In accordance with several embodiments of the invention, the explicit random events in an entertainment game provided by a gambling hybrid game are harnessed to drive gambling events in a gambling game in concert with the play of the entertainment game. For purposes of this discussion, a gambling hybrid game that uses the random events in an entertainment game to determine the results of the gambling event and/or wagers on the gambling event are referred to as a Gambling Integrated Game (GIG). A GIG uses the random events inherent in the underlying entertainment game as a gambling game where the outcome of a random event or a set of random events in the entertainment game is linked to the provisions of awards to a player. Examples of awards in accordance with embodiments of the invention include, but are not limited to, in-game objects, the alteration of in-game variables, and the allocation of credits to one or more pools being collected by the game operator (i.e. casino). A flow diagram of a process for providing a gambling hybrid game with a GIG in accordance with embodiments of the invention is illustrated in FIG. 8.

In process 1400, the player begins play of the gambling hybrid game (1405). Upon starting the game, the player selects (1410) between using either a player account to provide Real World Credits (RWC) and/or game world credits (GWC) for play (1412) or may play a stand-alone or host version (1411) of the game in which RWC and/or GWC is entered on a per-play basis. Regardless of the selected type of game play, the player then chooses the denominations or wagering amount to use during game play (1415). The ESE then provides the game play of the entertainment game (1420). During game play of the entertainment game, the player initiates a random event (1425).

The results of the random event are generated and the awards and/or wager results in the gambling game based upon the random event are determined. The results of the wagers and/or awards are provided to the player and displayed as part of the game play (1435). For example, a gambling hybrid game with a gambling integrated game provides a computerized version of the game of Monopoly®. In the game, a player rolls two 6-sided die each turn. In addition to dictating how far the player moves his piece in the entertainment game, the dice roll determines which one of the 36 possible permutations (where die 1 and die 2 are called out separately) or 21 permutations (where only sum of the dice is called out) corresponds to a specific monetary payout relative to the credits committed to the gambling game before the dice were “rolled” in a GIG version of Monopoly®. In accordance with some embodiments of a Monopoly® GIG, each of the 36 or 21 possible permutations correspond to at least one of a payout to the player, a possible allocation to a bonus pool, the alteration of an in-game variable, a loss of funds by the player, and a gain of funds by the player.

In accordance with some embodiments, the results of wagers and/or awards can include, but are not limited to contribution to a bonus pool that is awarded as a function of subsequent random events; a RC win for the player; a RC loss for the player; a RC draw for the player; a contribution to a bonus pool that is awarded as a function of player skill and/or as a function of a player's performance in one or more instances of the entertainment game; a contribution to an interstitial credit, such as Quanta, that the player can use in the current game session and/or over multiple game sessions to alter entertainment game variables; a contribution to a specific entertainment game variable without player selection or input; and a contribution to a bonus pool that is applied to a subsequent competition or tournament that the player may or may not become eligible to enter based upon factors including, but not limited to, the demonstrated skill of the player in the entertainment game, money committed to the gambling game, hours spent playing the game, and player club status. In accordance with some embodiments, the award and/or wager may be provided in lieu of the random event affecting the entertainment game. For example, the player may gain the ability to move their piece or one of the above effects may take place in a gambling hybrid game providing a Monopoly® game as an entertainment game in accordance with an embodiment of the invention. In accordance with the embodiment, the results of the random event may be affected by direct allocation of each possible random outcome to one of the above mentioned outcomes in a gambling game or a move in the entertainment game. For example, a first die roll of a “2” and a second die roll of a “5” may result in a RC win and no longer provide a move of seven squares in the Monopoly game. In accordance with some embodiments, an addition of an additional random number generating element (a third die for example) is introduced into the entertainment game that causes the fundamental random number generating element (the two dice) to be interpreted as either a conventional move in the underlying entertainment game, or instead as one of the above effects. In accordance with a number of embodiments, the impact of the underlying explicit random number generating mechanism in the entertainment game may be accumulated over multiple occurrences of the explicit random events in the entertainment game. For example, rather than the outcome of a single roll of the dice by a player during a player turn in Monopoly® which would limit the outcome to one of 36 distinct outcomes, the results of multiple dice rolls accumulated across several turns may be considered at one time so that a greater number of permutations of the result are possible. For example, six rolls of the two dice by a single player or the rolls from six player turns may be used to drive the Random Effect to provide 612 possible outcomes. After the results of the random event are determined and displayed, game play of the entertainment game continues (1440).

Although specific processes for providing gambling hybrid games with a GIG are discussed above with respect to FIG. 8, any of a variety of processes for providing a gambling hybrid game with a GIG can be utilized as appropriate to the requirements of specific applications in accordance with embodiments of the invention.

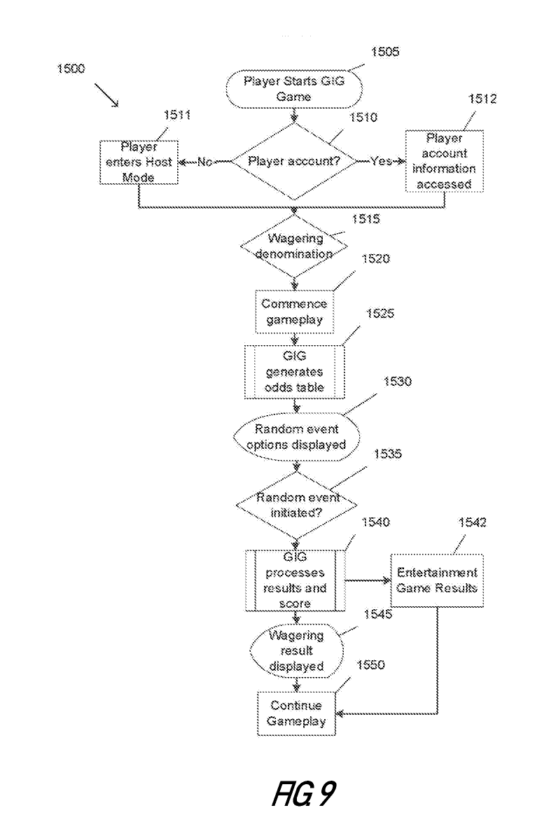

In accordance with some embodiments, the entertainment game in a gambling hybrid game with a GIG has different random events that may be initiated at a given time. The results of a gambling event corresponding to the random event may depend on the odds associated the random event initiated. A flow diagram of a process for providing a GIG with different odds for a random event in accordance with an embodiment of the invention is shown in FIG. 9.

In process 1500, the player begins play the gambling hybrid game (1505). Upon starting the game, the player selects (1510) between using either a player account to provide Real World Credits (RWC) and/or game world credits (GWC) for play (1512) or may play a stand-alone or host version (1511) of the game in which RWC and/or GWC is entered on a per-play basis. Regardless of the selected type of game play, the player chooses the denominations or wagering amount to use during game play (1515). The entertainment engine then provides the game play of the entertainment game (1520). The odds for each random event option are then determined for the GIG (1525) and displayed to the player (1530). During game play, the player initiates a random event from the random event options (1535). The results of the initiated random event are generated and the awards in the gambling game based upon the random event are determined. The results of any wagers and/or rewards are provided to the player and displayed as part of the game play (1540). The results of the random event on game play of the entertainment are determined (1542). The determined outcomes of wagers and/or awards provided to the player based upon the random event are displayed (1545) and game play of the entertainment game continues (1540). The determination of the results of the random event is performed in a manner similar to the determination described above with reference to FIG. 8.

Although a specific process for providing a gambling hybrid game with a GIG is discussed above with respect to FIG. 9, any of a variety of processes for providing a gambling hybrid game with a GIG can be utilized as appropriate to the requirements of specific applications in accordance with embodiments of the invention.

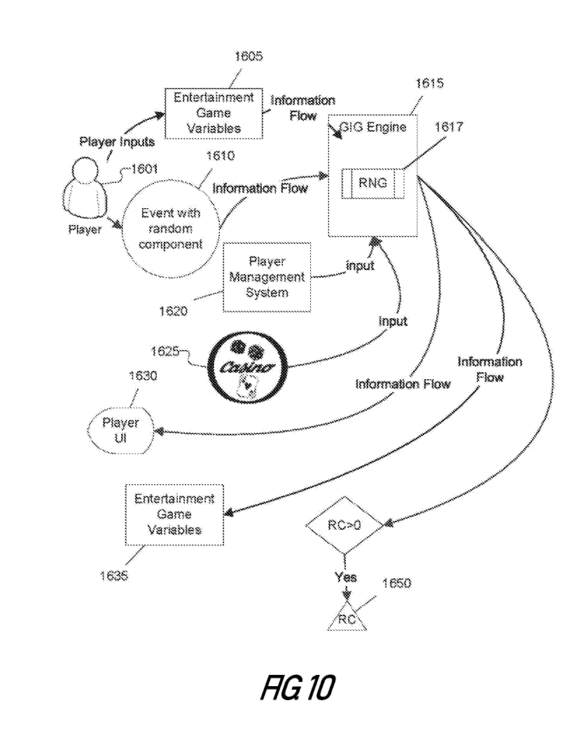

In accordance with many embodiments of the invention, the determination of the payout of a wager and/or award based upon the results of a random event in the entertainment game may be influenced by other information. This information includes, but is not limited to, Entertainment Game (EG) variables; player information; and casino and/or game provider information. A flow diagram showing the passing of information during the provision of a gambling hybrid game with a GIG in accordance with embodiments of the invention is illustrated in FIG. 10.

Player 1601 provides player inputs to the entertainment game. The inputs cause the entertainment game to update EG variables 1605 that indicate the state of the entertainment game. The player inputs also initiate an event with a random component 1610. EG variables 1605 and information about the event with a random component 1610 are provided to a GIG engine. The GIG engine also receives player information from a player management system 1620 and provider information from a casino and/or a game provider 1615. Random Number Generator (RNG) 1617 can be used to determine the results of the event with a random component 1610 in the entertainment game and the gambling game. The entertainment game uses the results of the event with a random component to update the EG variables 1635 and the player user interface 1630. The gambling game uses the results of the event with a random component to determine the results of the gambling event 1645 and any RC 1650 rewarded for wagers based upon the results of the gambling game.

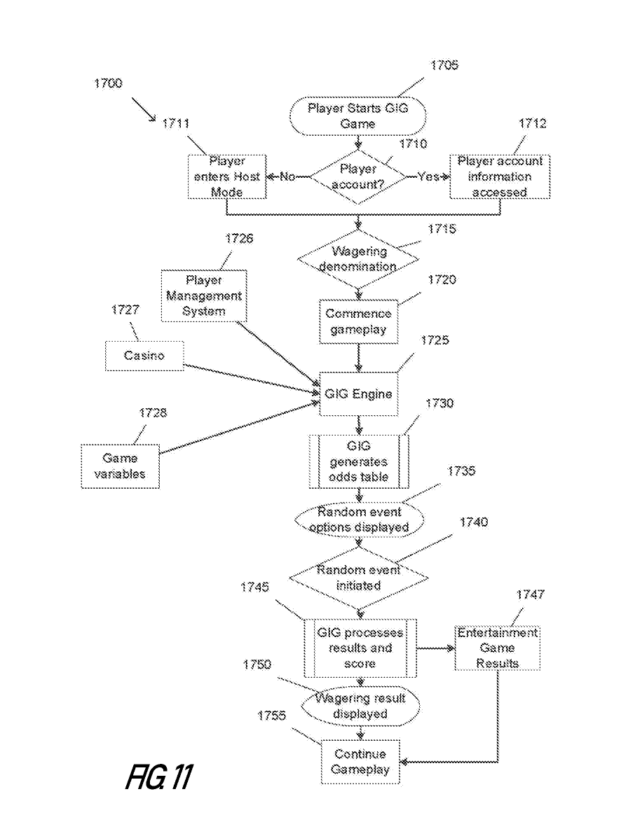

A flow diagram of a process for providing a GIG that uses the results of a random event and other information to determine the results of the random event in the entertainment game to determine results in a gambling event in a gambling game in accordance with an embodiment of the invention is shown in FIG. 11.

In process 1700, the player begins play of the gambling hybrid game (1705). Upon starting the game, the player selects (1710) between using either a player account to provide Real World Credits (RWC) and/or game world credits (GWC) for play (1712) or may play a stand-alone or host version (1711) of the game in which RWC and/or GWC is entered on a per-play basis. Regardless of the selected type of game play, the player chooses the denominations or wagering amount to use during game play (1715). The entertainment engine then provides the game play of the entertainment game (1720). The GIG engine receives player information from player management system 1726, EG variables 1728 from the ESE and provider information from the casino or game provider 1727. The odds for each random event option may then be determined for the GIG using the player information, provider information, EG variables, and other entertainment game information (1730) and displayed to the player (1735). During game play, the player initiates a random event from the random event options (1740). The results of the initiated random event are determined and the awards in the gambling game based upon the random event, the player information, provider information, and EG variables are determined and the results of any wagers and/or rewards are provided to the player and displayed as part of the game play (1745). The results of the random event on game play of the entertainment are determined (1747). The results of the wagers and/or awards provided to the player based upon the random event are displayed (1750) and game play of the entertainment game continues (1755).

Although a specific process for providing a gambling hybrid game with a GIG is discussed above with respect to FIG. 11, any of a variety of processes for providing a gambling hybrid game with a GIG can be utilized as appropriate to the requirements of specific applications in accordance with embodiments of the invention.

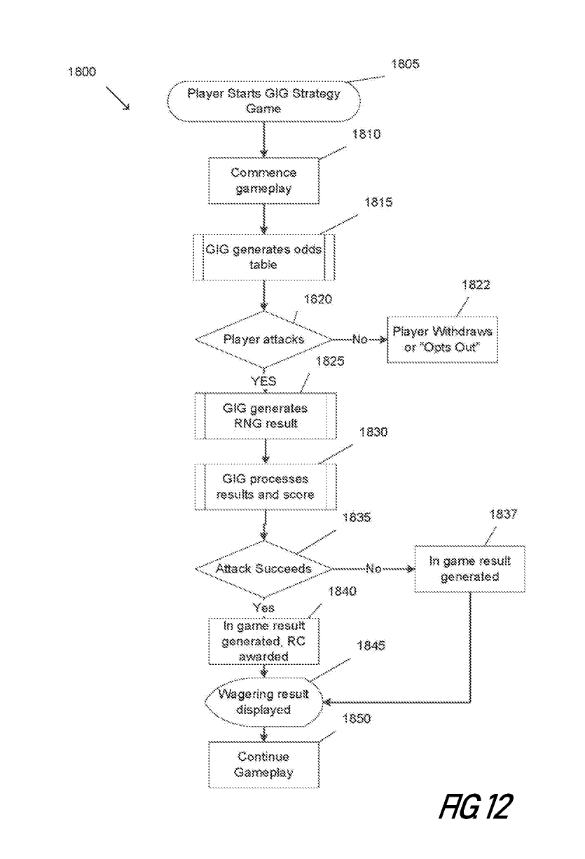

In accordance with some embodiments of a gambling hybrid games with a GIG, the entertainment game provided is a strategy-based game such as, Risk®. A flow diagram of a process for providing a GIG with a strategy game as the entertainment game is shown in FIG. 12. In process 1800, the player initiates the strategy-based entertainment game (1805). Game play of the strategy-based game commences (1810). As game play proceeds, the GIG generates an odds table for a random event. The player then initiates the random event (1820). An example of a random event in Risk® is when a player attacks a country on the game board occupied by a troop of another player. The attack continues until the player wins or withdraws (1822). For each roll of the dice during the attack, the GIG generates a random result using the RNG (1825). The GIG then processes the results of the random event in the gambling game and the results of the random event in the entertainment game (1830). If the attack fails (1837), the in-game results are recorded and game play of the entertainment game continues (1850). If the attack is successful, the in-game results of the successful attack are recorded and the award and/or results of wagers in the gambling game are determined (1840). The awards and/or results of the wagers are displayed (1845) and game play of the entertainment game continues (1850).

Although a specific process for providing a gambling hybrid game with a GIG providing a strategy game as the entertainment game is discussed above with respect to FIG. 12, any of a variety of processes for providing a gambling hybrid game with a GIG can be utilized as appropriate to the requirements of specific applications in accordance with embodiments of the invention.

In accordance with an embodiment of a gambling hybrid game with a GIG that provides the game of Risk® as the entertainment game, players engage in battles between groups of armies using one, two or three dice each, depending upon the number of armies each player is using to attack or defend. Over the course of a battle, there can be multiple rolls of the dice until one party is victorious or the attacker withdraws. The set of combinations of dice are known as a function of the number of troops each party uses in the battle. Each party is required in this example to contribute a specific sum of RC to each battle as a function of the number of troops that the party has committed to that battle as a whole in accordance with the embodiment. However, in accordance with other embodiments, RC is committed at a fixed amount per battle regardless of the number of troops committed. In accordance with still other embodiments, the amount of RC committed is a function of the number of dice rolled during each round of a battle. The combination of dice outcomes can be used to drive one or more of the following: a contribution to a pool to be paid to the winner of the specific head-to-head battle; a contribution to a tournament pool to which the players may or may not ultimately gain entry; and a contribution to a pool to be paid to the winner of the specific game. In several embodiments, there is no feedback from the gambling game to the entertainment game other than that already inherent in the Risk® game. In particular, the winner of the battle gains more territory and territory cards and may therefore ultimately receive more armies at the onset of the next turn of the winner. In accordance with other embodiments, one or more of the dice outcomes may cause a player to receive an award. Examples of awards include, but are not limited to additional armies; and special features including, but not limited to, extra attack dice for an attach, better attack odds, and better defending odds.

In a particular example, Player 1 attacks Japan from Kamchatka with 10 troops. Player 2 defends Kamchatka with four troops. Therefore, Player 1 is required to commit 10 RC to the battle, and player 2 is required to commit four RC to the battle. The battle proceeds in the manner shown in the following table.

| | Player 1 | Player 2 | | |
|---|---|---|---|---|
| | Troops at | Troops at | | |
| | start of | start of | Player 1 | Player 2 |
| Battle Round | round | round | Dice Rolls | Dice Rolls |
| 1 | 10 | 4 | 2, 3, 4 | 3, 6 |
| 2 | 8 | 4 | 4, 4, 5 | 2, 6 |
| 3 | 7 | 3 | 2, 1, 3 | 5, 3 |
| 4 | 5 | 3 | 6, 5, 1 | 4, 5 |
| 5 | 5 | 1 | 3, 4, 2 | 4 |
| 6 | 4 | 1 | 6, 3, 4 | 5 |
| 7 | 4 | 0 | N/A | N/A |

As shown in the table, Player 1 takes over the country after six rounds of battle having lost six of his initial troops and Player 2 has lost all four of his troops. As a result of the battler the following random effects result in accordance with the embodiment:
A Victory Bonus—Player 1 receives a credit back from her commitment as a function of having won the battle. 1 credit returned to player 1;
A Strong Defender Bonus—Player 2 receives a credit back from his commitment as a function of having lost fewer troops than player 1. One credit to player 2; and
Game Victory Pool—1 credit from the attacking player (Player 1) is committed to a pool at the onset of the battle that will be awarded to the ultimate winner of the Risk® game.

The gambling outcome for Player 1 in the example is determined in the following manner. 8 RC from Player 1 are committed to the random outcome that is ultimately determined by the numerical sequence {2, 3, 4, 4, 4, 5, 2, 1, 3, 6, 5, 1, 3, 4, 2, 6, 3, 4}. The numerical sequence is looked up in a table that can be dynamically generated at the onset of the battle. The table reflects all the possible outcomes of the engagement (including either player withdrawing before being defeated) with regards to rolls of Player 1. Prizes are allocated to each possible numerical combination in the table as a function of a prescribed distribution of outcomes dictated by the game. The prizes may be RC; in-game variables; in-game objects; or other items of value in accordance with the embodiment. The outcome of the process may be represented to Player 1 graphically through a variety of means including, but not limited to, a graphical representation of a slot machine or other gambling game. In the specific example, Player 1 loses the gambling game and is not awarded any RC.

The gambling outcome for Player 2 is determined in the following manner. 3 RC from Player 2 are committed to the random outcome that is ultimately determined by the numerical sequence {3, 6, 2, 6, 5, 3, 4, 5, 4, 5}. The numerical sequence is looked up in a table that can be dynamically generated at the onset of the battle, and which reflects all the possible outcomes of that engagement (including Player 2 withdrawing before being conquered) with regards to the rolls of Player 2. Prizes are allocated to each possible numerical combination in the table as a function of a prescribed distribution of outcomes dictated by the game. The prizes may be RC; in-game variables; in-game objects; or other items of value in accordance with the embodiment. The outcome of this process may be represented to Player 2 graphically through a variety of means including, but not limited to, a graphical representation of a slot machine or other gambling game. In this specific example, Player 2 wins the gambling game and is awarded 10 RC.

In the net, Player 1 loses 9 RCs net as a result of the battle and Player 2 gains 7 RCs. Further, 1 RC is allocated to a pool for the ultimate winner of the Risk® game.

In accordance with another embodiment of a gambling hybrid game with a GIG and providing Risk® as the entertainment game, an attack by Player 1 on a country protected by Player 2 is performed in the following manner. When player 1 attacks player 2 with a given number of troops on each side, the probability of Player 1 winning is at a known maximum. The probability can be less in so far as Player 1 may withdraw without completing the battle. However, maximum probability of Player 1 winning is known, and more specifically, the likelihood of Player 1 winning with N troops remaining is known. A following table can be constructed and shown to Player 1 before (or after) troops are committed to the battle given the number of troops that Player 1 and Player 2 each have committed to the battle (ten and four respectively). The following table shows the odd of Player 1 winning with N troops remaining.

| | Percentage |
|---|---|
| | Odds of |
| | Winning with |
| | N troops |
| N | remaining |
| 10 | 0.04% |
| 9 | 0.4% |
| 8 | 6% |
| 7 | 12% |
| 6 | 14% |
| 5 | 18% |
| 4 | 21% |
| 3 | 15% |
| 2 | 14% |
| 1 | 5% |

The above percentages are for exemplary purposes only and do not add to 100% because there is also the prospect of the Player 1 losing the battle. The following table adds a third column and an additional data point (the case of withdrawal or loss) to the above table to show Player 1 the credits awarded for a 10 credit bet based on the outcome of the battle. This table will be generated by the game logic with input from the casino, regulator, and/or other providers to reflect the desired gambling performance/volatility of the game. In accordance with this embodiment, only the attacking party will have a gambling game initiated as a function of committing troops to the battle. However, it is possible to provide a similar gambling game to the defending party using a similar process in accordance with some embodiments. Furthermore, the percentage odds in the second column could be represented to the player as odds as opposed to percentages in accordance with some embodiments. For example, the table could show “1-in-500” instead of “0.2%”.

| | Percentage | |
|---|---|---|
| | Odds of | |
| | Winning with | Payout on 10 |
| | N troops | committed |
| N | remaining | credits |
| 10 | 0.2% | 1000 |
| 9 | 4% | 250 |
| 8 | 12% | 100 |
| 7 | 11% | 11 |
| 6 | 10% | 10 |
| 5 | 7% | 8 |
| 4 | 5% | 1 |
| 3 | 5% | 0 |
| 2 | 4% | 0 |
| 1 | 3% | 0 |
| LOSS OR | 36.8% | 0 |
| WITHDRAWAL | | |

In the above table, the percentages are for exemplary purposes only.

Player 1 commits to the battle after looking at the above table and the battle plays out in step-wise fashion where the attacker decides whether to continue or withdraw after each roll. In accordance with the embodiment, the attacker's funds are committed, and withdrawal at any time leads to a complete loss of the committed funds. However, the game may provide the player with an “opt out” after each round where the player would lose some but not all of the committed credits in accordance with some embodiments. For example, Player 1 may want to “opt out” after a single round of the battle in response to a roll of the three die that led to the loss two troops. Player 1 may “opt out” at the cost of 5 RC or some other substantial penalty).

Once the battle is complete, Player 1 is paid out according to the above table. As in the previous embodiment, a portion of the funds committed by the player may also be allocated to a number of different pools. For example, a single credit may be allocated to a pool to be awarded to the overarching winner of the Risk® game in accordance with the embodiment. Another credit may be awarded to the defender for winning the battle in accordance with the embodiment. If the defender wins the battle the credit, as with all, may be allocated from an overarching pool as controlled by the game and/or casino; or may be directly shifted from Player 1 to Player 2 depending on the embodiment. Another credit may be allocated to a tournament pool in accordance with the embodiment. Allocations of credits played in a bonus round that relates to skill and/or gambling (i.e. luck) can also be made in accordance with some embodiments. Each type of allocation the funds can be drawn directly from player contributions or an overarching marketing pool that is not explicitly tied to the flow of credits during a given game session.

After Player 1 is paid out according to the above table, play continues as before. In accordance with this example, game play continues by Player 1 continuing the turn until complete. Player 2 then drafts armies, places the armies on the board, attacks adjacent enemy territories (and gambles) as desired, and then moves troops before ending his turn. The process is repeated for each player (including computer driven players) in the game until the game is completed.

In accordance with another embodiment of a gambling hybrid game with a GIG having Risk® as the entertainment game, the Risk® game may be implemented in a GIG context where the aforementioned table operates not in context of a payout for a specific battle victory scenario (e.g. a win with 7 troops remaining) but to pay out as a function of winning with at least X troops remaining. This may be simpler to convey to the player. The table for determining payouts is shown in the following table where the percentages herein are exemplary only and not meant to be representative of the actual odds associated with the outcomes in a Risk® game.

| | | Payout on 10 |
|---|---|---|
| Player 1 Battle | Percentage | committed |
| Outcome | Odds | credits |
| Win with 10 | 0.2% | 1000 |
| troops | | |
| remaining | | |
| Win with 6+ | 35% | 15 |
| troops | | |
| remaining | | |
| Win with | 15% | 12 |
| 6 > x > 3 troops | | |
| remaining | | |
| Win with 3 or | 10% | 5 |
| fewer troops | | |
| remaining | | |
| Lose or | | 0 |
| withdraw | | |

One skilled in the art will recognize that the player need not be exposed to the odds explicitly when showing the possible payouts.

In accordance with still another embodiment of a gambling hybrid game with a GIG having Risk® as the entertainment game, a given battle consists of a number of rounds, or “attacks” made by the attacking player. For each attack, the attacking player can claw back a portion of a wager committed to the gambling game. The claw back is paid only if the player wins (or in some implementations wins or draws) the attack round and the player is paid as a function of the # of troops attacked relative to the # of troops defending as shown in the following general equation.

Claw Back per Attack Round=f(# of troops attacking,# of troops defending)

The following is an example of a specific clawback formula for game play in accordance with the embodiment:

$$A = \# of troops attacking$$

$$D = \# of troops defending$$

$$W = RC ( or VC ) committed to gambling game$$

$$Claw Back per Attack Round = C * W * ( \frac{D}{A} ) where D < A$$

$$Claw Back per Attack Round = C * W * ( \frac{A}{D} ) where D > A$$

Where C is defined as

$$C = 0.1 * ( \frac{1}{n} )$$

$$n = attack round in the given battle ( i . e . 1 , 2 , 3 , etc . )$$

In accordance with some embodiments, the claw back process can be limited by the game logic and/or the casino to persist only for a maximum of n rounds (e.g. 10). The above is a single example, and it is possible to construct any other manner of formulaic approach, including approaches that increase the claw back with each ongoing attack round, rather than decrementing it.

Beyond the claw back process, a payout to a player winning the battle is established as a function of the # of die “rolled” during the battle at the end of the battle in accordance with a number of embodiments. A series of tiers may be set as a function of the number of die rolled and prizes are allocated to each tier in accordance with some embodiments. A table dictating the prizes for each tier is used to establish the payout in accordance with many of the embodiments. The prizes can vary as a function of the ultimate performance of the die rolls relative to a given table. The prizes may also vary from table to table to account for the number of die rolls in a battle. For example, a table for a battle that entailed 5 die rolls for the attacker would likely have a much lower maximum payout than a table that reflected a battle that entailed 20 die rolls.

An example of tables in accordance with an embodiment of the invention that account for the different amount of die rolls in a battle is given below. The payouts are different because of the amount of RC committed is based on the number of die rolled during the battle in accordance with the embodiment. Each die roll result (e.g. a 1, 2, 3, 4, 5 or 6) of a player is added together to ascertain a player's score. The score is then cross-referenced against a table to establish a payout based on the number of die rolls by the player. The first table shows a table for 20 die rolls in accordance with embodiments of the invention.

| Dice Roll | Payout on 20 |
|---|---|
| Score for 20 | committed |
| Rolls | credits |
| 110 <= X | 5,000 |
| 100 <= X < 110 | 2,000 |
| 80 <= X < 100 | 100 |
| X = 20 | 20,000 |
| X < 80, X ≠ 20 | 0 |
| Lose or | NIL |
| withdraw | |

The following table is for a battle that only entailed 5 dice rolls. The payouts are less than payouts on the first table because the odds associated with the various outcomes are much greater than in the 20 die case.

| Dice Roll | Payout on 5 |
|---|---|
| Score for 5 | committed |
| Rolls | credits |
| 27 < X | 500 |
| 25 <= X <= 27 | 100 |
| 20 <= X < 25 | 10 |
| X = 5 | 1000 |
| X < 20, X ≠ 5 | 0 |
| Lose or | NIL |
| withdraw | |

In addition to the gambling mechanisms in a GIG described for the above embodiments, GWC may be accumulated as a function of battles won in accordance with some embodiments. In many embodiments, any battle won would generate the same amount of GWC. In accordance with many embodiments, the payout of GWC is a function of the ratio of the number of initial troops of the winner of the battle relative to number of initial troops of the loser. GWC may also be awarded to a player losing a battle if the player's performance in the battle was “heroic” in accordance with a number of embodiments. For example, the player destroyed 20 attacking troops before losing the 3 defending troops. The amount of GWC and/or the player's ultimate status at the end of the game (1st place, 2nd, etc.) may dictate in whole or in part the awarding of a fixed or variable cash prize and/or count towards entry into a tournament (i.e. a player may need a fixed amount of GWC accumulated through Risk® play to gain entry) in accordance with some embodiments of the invention. Other variables may also introduced by the casino could also affect the prize in accordance with a number of embodiments.

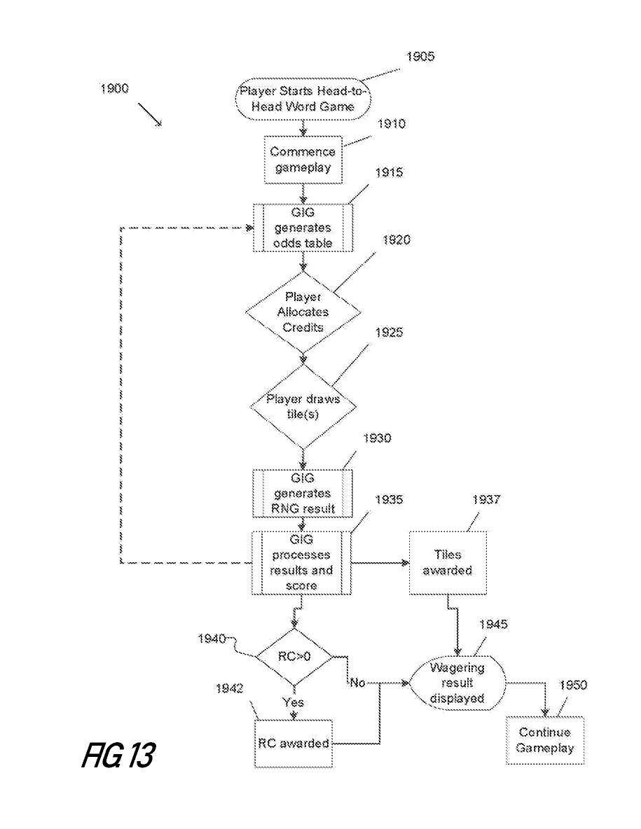

A second example of a gambling hybrid game with a GIG in accordance with embodiments of the invention provides a word game as an entertainment game. In a word game, a player randomly selects tiles of letters from a pool of tiles and attempts to place words on a game board using the selected tiles. An example of a word game is Scrabble®. The GIG drives gambling events based upon the random nature receiving tiles from the pool. At the time the tiles are selected, the odds associated with pulling any specific combination of letters from the pool are known. As such, gambling propositions can be offered to the player each time that she selects tiles from the pool as part of the overarching game play. As with any GIG game, the player can be offered a prescribed gambling game, and/or have the option to choose from one or more gambling games in accordance with embodiments of the invention. A process for providing gambling hybrid game with a GIG game based upon a word game in accordance with embodiments of the invention is shown in FIG. 13.

In process 1900, the player initiates the gambling hybrid game with a word game as the entertainment game (1905). Game play of the word game commences (1910). At the beginning of a player's turn, the GIG generates odds tables for pulling a specific combination of letters (1915). The player then allocates wagers to a bet on one or more of the specific combinations of letters. The player then receives the tiles with letters from the pool of tile (1925) based upon the results of RNG provided by the GIG (1930). The GIG then processes the results of the tiles received (1937) by the player and resolves any wagers and/or awards based upon the tiles received (1940). Depending on the results, the process may be repeated to provide other wagers and/or random events. The results of the wager (1940) and any RC won based wagers (1942) are then displayed to the player (1945) and game play continues (1950).

Although a specific process for providing a gambling hybrid game with a GIG providing a word game as the entertainment game is discussed above with respect to FIG. 13, any of a variety of processes for providing a gambling hybrid game with a GIG can be utilized as appropriate to the requirements of specific applications in accordance with embodiments of the invention.

For example, a player turn may occur as follows. A player receives three tiles from the pool to replace tiles used to form a word on the game board. To obtain the tiles, player commits three RC to one or more gambling games based upon previous decisions by the player in the context of casino provided choices. The GIG offers the player a high volatility, a mild volatility and a low volatility proposition as follows: a high volatility proposition is “Draw A-A-A and win 2000 credits per credit bet”; a medium volatility proposition is “Draw two vowels and win 2 credits per credit bet”; and a low volatility proposition is “Draw three consonants and win 10 credits per credit bet”.

The player can allocate the three credits in any of the following manners: one of the three credits to each of the above propositions; two credits to one proposition and the third credit to a second proposition; or all three credits to a single proposition. In accordance with a number of embodiments, the game shows the player the odds associated with each available bet. In accordance with many embodiments, the player may not be provided choices. Instead, the player is provided a pre-structured table of potential outcomes such as the following table. In accordance with some embodiments, the percentage odds can be constructed given the number of tiles that need to be drawn, and the tiles remaining in the bag with blank tiles considered as wild cards. The player may or may not be shown the column “Percentage Odds of Drawing this Tile Set” depending on the embodiment.

| | Percentage | |
|---|---|---|
| Tiles Pulled | Odds of | Payout on 3 |
| (order is | Drawing this | committed |
| significant) | Tile Set | credits |
| A-A-A | 0.1% | 250 |
| Two vowels | 36% | 3 |
| and one | | |
| consonant | | |
| Three | 12% | 4 |
| consonants | | |
| Three vowels | 12% | 4 |
| C-O-W | 0.005% | 3,000 |
| D-O-G | 0.003% | 10,000 |
| Three vowels | 12% | 4 |
| All others | 17% | 0 |

One skilled in the art will recognize that the above percentages are for illustrative purposes only and the exact percentages can change as game play proceeds. During each turn, the player will see a new set of payout possibilities immediately before drawing tiles from the bag. In accordance with some embodiments, display of the table may be initiated by the player using a button; an on-screen control; and/or some other mechanism. In general, the GIG can structure the payouts and select the winning options to provide the same overarching expected payout per gambling game in accordance with many embodiments. In a number of embodiments, the volatility can vary from the onset of the game towards the end of the game. During game play of certain games, such as “Words With Friends”, the number of tiles in the bag diminishes as the game progresses causing the range of outcomes to narrow. As a result, it may not be possible to provide an equivalent distribution of outcomes or volatility as when the game commenced.

In accordance with some embodiments of a gambling hybrid game with a GIG and providing a word game as the entertainment game, or any GIG, it is also possible to offer gambling propositions that span multiple turns of the same player or multiple turns inclusive of more than one player. Because of the dependencies across player turns, and the fact that it is unknown how many tiles will be drawn in subsequent turns, this specific aspect may not be applicable in Words with Friends. However, spanning gambling propositions across multiple turns may be practical in other entertainment games where the explicit random elements are consistent from turn to turn. For example, in the game of LIFE®, the player spins the same spinner each turn, generating a random number between 1 and 10.

In accordance with some embodiments, tournament entry for play of gambling hybrid games with a GIG can be governed by overall GWC won, such that GIG games can each have a schema for awarding points for a player's in-game performance. Tournament entry can also be governed by a player's skill rating such that bands of skill can be established and players are given access to enter tournaments as a function of their demonstrated skill in accordance with a number of embodiments. Other requirements, such as number of games played, funds committed to games, a player's status vis-à-vis a casino's player's club, etc. can all impact eligibility to enter a tournament where the tournaments being be either for playing GIG game, or for playing the underlying entertainment game without the GIG component. Skill ratings can be established using a number of systems, including ELO or modified ELO systems that account for the gambling outcomes experienced by the player to various extents.

In accordance with some embodiments, head-to-head betting is also available in a gambling hybrid game with a GIG game. Odds can be set as a function of a player's skill rating, experience, or other factors. In accordance with a number of embodiments, players can set their own bet structures as a function of their knowledge about one another, and/or the subject of the bet (i.e. outright win vs. a specific in-game achievement, etc.).

Provision of a Gambling Hybrid Game with a GIG

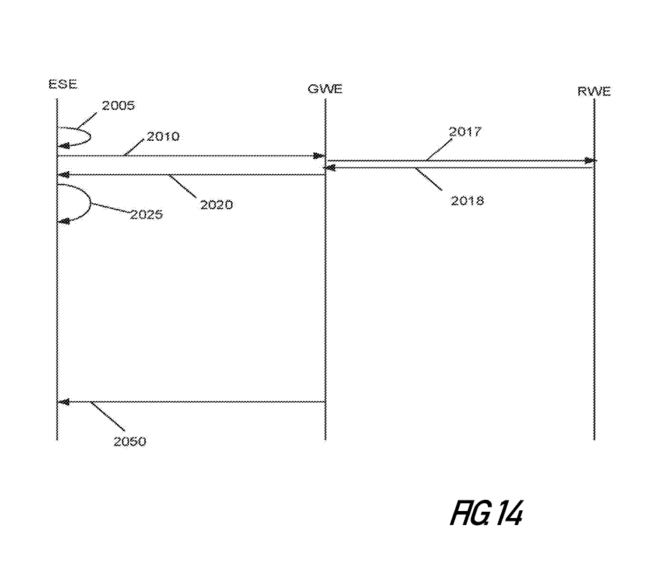

In accordance with several embodiments of the invention, the ESE, GWE, and RWE of a gambling hybrid game provides a GIG. A timing chart showing the processes performed by the ESE, GWE, and RWE and the communications between these components to provide a GIG in accordance with an embodiment of the invention is illustrated in FIG. 14. The ESE provides an entertainment game in which randomized events are utilized to implement the game rules of the entertainment game. During the play of the entertainment game, game events 2010 are communicated by the ESE to a GWE. The GWE receives the game events and determines that a resolution to a randomized event is needed by the ESE. The GWE communicates a request 2017 to the RWE for a randomized outcome. The RWE receives the request and determines a randomized outcome 2018. The randomized outcome includes a gambling outcome that is a result of a wager in accordance with a gambling proposition or gambling game involving real or virtual credits. The randomized outcome also includes random outcome information that is used by the GWE to resolve the randomized event in the entertainment game. The randomized outcome is communicated by the RWE to the GWE. In some embodiments, the GWE uses the randomized outcome information to resolve the randomized event for the ESE. The GWE then communicates a resolution to the randomized event 2020 to the ESE. The ESE receives the resolution to randomized event from the GWE and implements 2025 the resolution within the entertainment game.

In some embodiments, the GWE does not resolve the randomized event for the ESE. Instead, the GWE communicates the random outcome information to the ESE and the ESE generates the resolution to the randomized event.

In some embodiments, the GWE determines the random outcome information instead of the RWE.

While the above description may include many specific embodiments of the invention, these should not be construed as limitations on the scope of the invention, but rather as examples of embodiments thereof. It is therefore to be understood that the invention can be practiced otherwise than specifically described, without departing from the scope and spirit of the invention. Thus, embodiments of the invention described herein should be considered in all respects as illustrative and not restrictive.

What is claimed:

1. A system for providing a gambling hybrid game that includes an entertainment game of skill and a gambling game, comprising:
a processing device, connected to a game world server via a network, constructed to:
execute the entertainment game of skill to resolve a random event in the entertainment game of skill to generate a random event result;
detect the random event is to occur during execution of the entertainment game of skill;
communicate, to the game world server via the network, a signal including the random event result;
receive, from the game world server via the network, a signal including a wager result based upon the random event result; and
display the wager result based upon the random event result;
a real world server, connected to the game world server via a communication link, constructed to:
receive, from the game world server via the communication link, a signal including a request of a resolution to the wager based on the random event result;
determine the wager result based upon the random event result; and
communicate, to the game world server via the communication link, the signal including the wager result based upon the random event result; and
the game world server, connected to the processing device via the network and connected to the real world server via the communication link, constructed to:
continuously monitor the processing device for the signal including the random event result;
receive, from the processing device via the network, the signal including the random event result;
determine whether to request a resolution to the wager based on the signal including the random event result;
communicate, to the real world server via the communication link, the signal including the request of the resolution to the wager based on the random event result;
receive, from the real world server via the communication link, the signal including the wager result based upon the random event result; and
communicate, to the processing device via the network, the signal including the wager result based upon the random event result.

2. The system of claim 1, wherein the game world server receives player information from a player management system and uses the random event result and the player information to determine the wager result for the random event.

3. The system of claim 1, wherein the game world server receives game provider information from a game provider system and uses the random event result and the game provider information to determine the wager result for the random event.

4. The system of claim 1, wherein the wager result contributes to a bonus pool that is awarded as a function of a subsequent random event.

5. The system of claim 1, wherein the game world server generates an odds table for the random event.

6. A system for providing a gambling hybrid game that includes an entertainment game of skill and a gambling game, comprising:
a processing device, connected to a game world server via a network, constructed to:
execute the entertainment game of skill to resolve a random event in the entertainment game of skill to generate a random event result;
detect the random event is to occur during execution of the entertainment game of skill;
communicate, to the game world server via the network, a signal including the random event result;
receive, from the game world server via the network, a signal including a wager result based upon the random event result; and
display the wager result based upon the random event result; and
the game world server, connected to the processing device via the network and connected to a real world server via a communication link, constructed to:
continuously monitor the processing device for the signal including the random event result;
receive, from the processing device via the network, the signal including the random event result;
determine whether to request a resolution to the wager based on the signal including the random event result;
communicate, to the real world server via the communication link, the signal including the request of the resolution to the wager based on the random event result;
receive, from the real world server via the communication link, the signal including the wager result based upon the random event result; and
communicate, to the processing device via the network, the signal including the wager result based upon the random event result.

7. The system of claim 6, wherein the game world server receives player information from a player management system and uses the random event result and the player information to determine the wager result for the random event.

8. The system of claim 6, wherein the game world server receives game provider information from a game provider system and uses the random event result and the game provider information to determine the wager result for the random event.

9. The system of claim 6, wherein the wager result contributes to a bonus pool that is awarded as a function of a subsequent random event.

10. The system of claim 6, wherein the game world server generates an odds table for the random event.

11. A system for providing a gambling hybrid game that includes an entertainment game of skill and a gambling game, comprising:
a real world server, connected to a game world server via a communication link, constructed to:
receive, from the game world server via the communication link, a signal including a request of a resolution to a wager based on a random event result;
determine the wager result based upon the random event result; and
communicate, to the game world server via the communication link, a signal including the wager result based upon the random event result; and
the game world server, connected to a processing device via a network and connected to the real world server via the communication link, constructed to:
continuously monitor the processing device for a signal including the random event result;
receive, from the processing device via the network, the signal including the random event result;
determine whether to request a resolution to the wager based on the signal including the random event result;
communicate, to the real world server via the communication link, the signal including the request of the resolution to the wager based on the random event result;
receive, from the real world server via the communication link, the signal including the wager result based upon the random event result; and
communicate, to the processing device via the network, the signal including the wager results based upon the random event result.

12. The system of claim 11, wherein the game world server receives player information from a player management system and uses the random event result and the player information to determine the gambling result for a random event.

13. The system of claim 11, wherein the game world server receives game provider information from a game provider system and uses the random event result and the game provider information to determine the gambling result for a random event.

14. The system of claim 11, wherein the wager result contributes to a bonus pool that is awarded as a function of a subsequent random event.

15. The system of claim 11, wherein the game world server generates an odds table for a random event.
